(19) United States
(12) Patent Application Publication
(10) Pub. No.: US 2022/0272335 A1
(43) Pub. Date: Aug. 25, 2022

(54) CROSS-COMPONENT ADAPTIVE LOOP FILTER

(71) Applicants: Beijing Bytedance Network Technology Co., Ltd., Beijing (CN); Bytedance Inc., Los Angeles, CA (US)

(72) Inventors: Hongbin LIU, Beijing (CN); Li ZHANG, San Diego, CA (US); Kai ZHANG, San Diego, CA (US); Yue WANG, Beijing (CN)

(21) Appl. No.: 17/735,435

(22) Filed: May 3, 2022

Related U.S. Application Data
(63) Continuation of application No. PCT/CN2020/126332, filed on Nov. 4, 2020.

(30) Foreign Application Priority Data
Nov. 4, 2019 (CN) PCT/CN2019/115321

(51) Int. Cl. H04N 19/117; H04N 19/82; H04N 19/186

(52) U.S. Cl. CPC H04N 19/117; H04N 19/186; H04N 19/82

(57) ABSTRACT

A method of video processing is described. The method includes determining, for a conversion between a current video unit of a video including one or more video blocks and a bitstream representation of the video, a padding process used for padding unavailable samples during application of a cross-component adaptive loop filtering (CC-ALF) tool to at least some video blocks of the current video unit according to a rule; and performing the conversion based on the determining, and wherein the rule specifies that the padding process is also used for padding unavailable samples during application of an adaptive loop filtering (ALF) tool to one or more video blocks of the current video unit.

### CROSS REFERENCE TO RELATED APPLICATIONS

This application is a continuation of International Patent Application No. PCT/CN2020/126332, filed on Nov. 4, 2020, which claims the priority to and benefits of International Patent Application No. PCT/CN2019/115321, filed on Nov. 4, 2019. All the aforementioned patent applications are hereby incorporated by reference in their entireties.

### TECHNICAL FIELD

This patent document relates to video coding and decoding techniques, devices and systems.

### BACKGROUND

Currently, efforts are underway to improve the performance of current video codec technologies to provide better compression ratios or provide video coding and decoding schemes that allow for lower complexity or parallelized implementations. Industry experts have recently proposed several new video coding tools and tests are currently underway for determining their effectivity.

### SUMMARY

Devices, systems and methods related to digital video coding, and specifically, to management of motion vectors are described. The described methods may be applied to existing video coding standards (e.g., High Efficiency Video Coding (HEVC) or Versatile Video Coding) and future video coding standards or video codecs.

In one representative aspect, the disclosed technology may be used to provide a method for video processing. This method includes determining, for a conversion between a current video unit of a video comprising one or more video blocks and a bitstream representation of the video, a padding process used for padding unavailable samples during application of a cross-component adaptive loop filtering (CC-ALF) tool to at least some video blocks of the current video unit according to a rule; and performing the conversion based on the determining and wherein the rule specifies that the padding process is also used for padding unavailable samples during application of an adaptive loop filtering (ALF) tool to one or more video blocks of the current video unit.

In another representative aspect, the disclosed technology may be used to provide another method for video processing. This method includes performing a conversion between a video unit of a video and a bitstream representation of the video, wherein, during the conversion, unavailable samples of the video unit are padded in a predefined padding order according to a rule in an application of an adaptive loop filtering (ALF) process or a cross-component adaptive loop filtering (CC-ALF) process.

In yet another representative aspect, the disclosed technology may be used to provide another method for video processing. This method includes determining, for a video region of a video for which an application of an adaptive loop filter (ALF) is enabled, that the video region is crossed by a boundary of a video unit; and performing a conversion between the video and a bitstream representation of the video, wherein, for the conversion, the video region is split into multiple partitions according to a rule due to the video region being crossed by the boundary of the video unit.

In yet another representative aspect, the disclosed technology may be used to provide another method for video processing. This method includes performing a conversion between a video unit of a video and a bitstream representation of the video according to a rule, wherein the rule specifies that applying an adaptive loop filtering (ALF) and/or a cross-component adaptive loop filtering (CC-ALF) to a sample located at a boundary of the video unit is disallowed in case that a filtering process across the boundary is disallowed.

In yet another representative aspect, the disclosed technology may be used to provide another method for video processing. This method includes performing a conversion between a video unit of a video and a bitstream representation of the video, wherein the bitstream representation conforms to a format rule; wherein the video region is different from a coding tree block; wherein the format rule specifies whether a syntax element is included in the bitstream representation indicative of an applicability of an adaptive loop filtering (ALF) tool and/or a cross-component adaptive loop filtering (CC-ALF) tool to the video region.

In yet another representative aspect, the disclosed technology may be used to provide another method for video processing. This method includes determining, for a conversion between a video unit of a video and a bitstream representation of the video, an applicability of a cross-component adaptive loop filtering (CC-ALF) tool to samples of the video unit according to a rule; and performing the conversion according to the determining; wherein the bitstream representation includes an indication that the CC-ALF is available for the video unit, and wherein the rule specifies one or more conditions that override the indication.

In yet another representative aspect, the disclosed technology may be used to provide another method for video processing. This method includes performing a conversion between a video unit of a video and a bitstream representation of the video according to a rule, wherein the rule specifies that an arithmetic used during the conversion omits at least one of three clipping operations that include a first clipping operation corresponding to a chroma adaptive loop filtering (ALF) filtering, a second clipping operation corresponding to a cross-component adaptive loop filtering (CC-ALF) offset derivation, and a third clipping operation corresponding to a refinement of a chroma filtered sample to derive a final chroma sample value.

In yet another representative aspect, the disclosed technology may be used to provide another method for video processing. This method includes making a determination, for a conversion between a first video unit of a video and a bitstream representation of the video, of a cross-component adaptive loop filtering (CC-ALF) offset according to a rule; and performing the conversion based on the determination, and wherein the rule specifies that the CC-ALF offset is clipped to a first range different from a second range that is expressed as [−(1<<(BitDepthC−1)), (1<<(BitDepthC−1))−1], wherein BitDepthC is a bit depth value.

In yet another representative aspect, the disclosed technology may be used to provide another method for video processing. This method includes deriving, for a conversion between a first video unit of a video and a bitstream representation of the video, a cross-component adaptive loop filtering (CC-ALF) offset according to a rule; and performing the conversion using the CC-ALF offset, and wherein the rule specifies that the CC-ALF offset is rounded with a rounding offset based on a bit-depth value instead of a fixed value.

In yet another representative aspect, the disclosed technology may be used to provide another method for video processing. This method includes performing a conversion between a video unit of a video and a bitstream representation of the video according to a rule, wherein the rule specifies that one or more processing steps used during a chroma adaptive loop filtering (ALF) process and/or a cross-component adaptive loop filtering (CC-ALF) process applied to samples of the video unit are same.

In yet another representative aspect, the disclosed technology may be used to provide another method for video processing. This method includes performing a conversion between a video unit of a video and a bitstream representation of the video according to a rule, wherein the rule specifies that, during the conversion, a value of a sample of a first color component of the video unit is modified by applying a modification using an information of a second color component of the video unit, wherein the modification is based on one or more parameters used in an adaptive loop filtering (ALF) process for the video unit.

In yet another representative aspect, the disclosed technology may be used to provide another method for video processing. This method includes making a determination, for a conversion between a first sub-picture of a video and a bitstream representation of the video, whether a cross-component loop filtering (CC-ALF) is applicable to a sample of the first sub-picture based on a rule; and performing the conversion based on the determining; wherein the CC-ALF for the sample uses samples from a second sub-picture; and wherein the rule is based on whether loop filtering across a sub-picture boundary is allowed for the first sub-picture and/or the second sub-picture.

Further, in a representative aspect, an apparatus in a video system comprising a processor and a non-transitory memory with instructions thereon is disclosed. The instructions upon execution by the processor, cause the processor to implement any one or more of the disclosed methods.

Also, a computer program product stored on a non-transitory computer readable media, the computer program product including program code for carrying out any one or more of the disclosed methods is disclosed.

The above and other aspects and features of the disclosed technology are described in greater detail in the drawings, the description and the claims.

### BRIEF DESCRIPTION OF THE DRAWINGS

FIG. 1 shows an example of an encoder block diagram.

FIG. 2 shows examples of geometry transformation-based adaptive loop filter (GALF) filter shapes.

FIG. 3 shows an example of a loop filter line buffer associated with a luma component.

FIG. 4 shows an example of a loop filter line buffer associated with a chroma component.

FIGS. 5A and 5B show examples of modified ALF block classification at virtual boundary when N=4

FIGS. 6A, 6B, and 6C show examples of 1 line, 2 lines, and 3 lines near a virtual boundary (VB) in connection with modified luma ALF filtering.

FIGS. 7A and 7B shows examples of 1 line and 2 lines near a virtual boundary (VB) in connection with modified chroma ALF filtering.

FIG. 8 shows examples of modified-coefficient based ALF (MALF).

FIGS. 9A to 9D shows example of subsampled Laplacian calculations.

FIG. 10A shows an example of placement of CC-ALF with respect to other loop filters.

FIG. 10B shows an example of a diamond shaped filter.

FIG. 11 shows an example of a 3×4 diamond shaped filter.

FIG. 12 shows an example of raster-scan slice partitioning of a picture.

FIG. 13 shows an example of rectangular slice partitioning of a picture.

FIG. 14 shows another example of rectangular slice partitioning of a picture.

FIG. 15 shows an example of subpicture partitioning of a picture.

FIG. 16 shows an example of an ALF processing unit and an example of a narrow ALF processing unit.

FIG. 17 shows an example of applying repetitive padding to an ALF processing unit.

FIG. 18 shows an example of padding of unavailable samples.

FIG. 19 is a block diagram of an example of a hardware platform for implementing a visual media decoding or a visual media encoding technique described in the present document.

FIG. 20 shows a flowchart of an example method for video processing.

FIG. 21 is a block diagram of an example video processing system in which disclosed techniques may be implemented.

FIG. 22 is a block diagram that illustrates an example video coding system.

FIG. 23 is a block diagram that illustrates an encoder in accordance with some embodiments of the disclosed technology.

FIG. 24 is a block diagram that illustrates a decoder in accordance with some embodiments of the disclosed technology.

FIGS. 25A to 25G show flowcharts of example methods of video processing based on some implementations of the disclosed technology.

### DETAILED DESCRIPTION

### 1. Video Coding in HEVC/H.265

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma sub sampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma sub sampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each sub sampled at a factor of 2 both horizontally and vertically. There are three variants of 4:2:0 schemes, having different horizontal and vertical siting.
In MPEG-2, Cb and Cr are co-sited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.1.4. Coding of Different Color Components

Depending on the value of separate_colour_plane_flag, the value of the variable ChromaArrayType is assigned as follows:
If separate_colour_plane_flag is equal to 0, ChromaArrayType is set equal to chroma_format_idc.
Otherwise (separate_colour_plane_flag is equal to 1), ChromaArrayType is set equal to 0.

### 2.2 Coding Flow of a Typical Video Codec

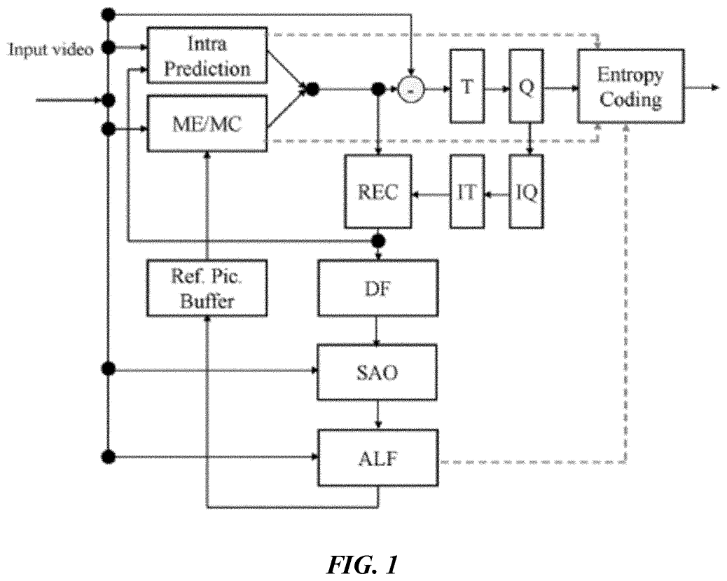

FIG. 1 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 2.3 Geometry Transformation-Based Adaptive Loop Filter in JEM

In the JEM, a geometry transformation-based adaptive loop filter (GALF) with block-based filter adaption is applied. For the luma component, one among 25 filters is selected for each 2×2 block, based on the direction and activity of local gradients.

### 2.3.1. Filter Shape

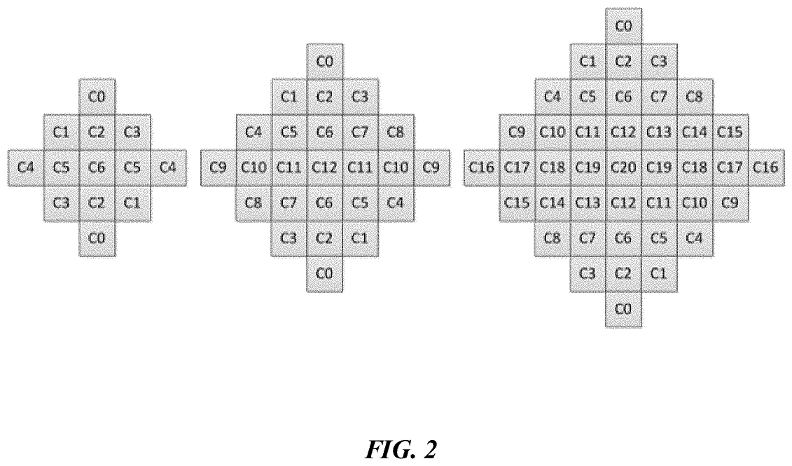

In the JEM, up to three diamond filter shapes (as shown in FIG. 2) can be selected for the luma component. FIG. 2 shows three GALF filter shapes, 5×5 diamond, 7×7 diamond, 9×9 diamond (from the left to the right). An index is signaled at the picture level to indicate the filter shape used for the luma component.

### 2.3.1.1. Block Classification

Each 2×2 block is categorized into one out of 25 classes. The classification index C is derived based on its directionality D and a quantized value of activity Â, as follows:

C=5D+Â. (1)

To calculate D and Â, gradients of the horizontal, vertical and two diagonal direction are first calculated using 1-D Laplacian:

$$\begin{matrix}{g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , & ( 2 ) \\ {g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , & ( 3 ) \\ {g}_{d 1} = {\sum }_{k = i - 2}^{i + 3} {\sum }_{l = j - 2}^{j + 3} D {1}_{k , l} , D {1}_{k , l} = \vert 2 R ( k , l ) - R ( k - 1 , l - 1 ) - R ( k + 1 , l + 1 ) \vert & ( 4 ) \\ {g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert & ( 5 )\end{matrix}$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

g_{h,v}^{max}=max(gₕ,gᵥ),g_{h,v}^{min}=min(gₕ,gᵥ), (6)

and the maximum and minimum values of the gradient of two diagonal directions are set as:

g_{d0,d1}^{max}=max(g_{d0},g_{d1}),g_{d0,d1}^{min}=min(g_{d0},g_{d1}), (7)

To derive the value of the directionality D, these values are compared against each other and with two thresholds t₁ and t₂:

Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{max}, continue from Step 3; otherwise continue from Step 4.
Step 3. If g_{h,v}^{max}>t₂·t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.3.1.2. Geometric Transformations of Filter Coefficients

Before filtering each 2×2 block, geometric transformations such as rotation or diagonal and vertical flipping are applied to the filter coefficients f (k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

Diagonal: f_{D}(k,l)=f(l,k),

Vertical flip: fᵥ(k,l)=f(k,K−l−1),

Rotation: f_{R}(k,l)=f(K−l−1,k). (9)

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) depending on gradient values calculated for that block. The relationship between the transformation and the four gradients of the four directions are summarized in Table 1.

TABLE 1
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.3.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f (k, l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.3.1.4. Filtering Process

At decoder side, when GALF is enabled for a block, each sample R(i,j) within the block is filtered, resulting in sample value R′(i,j) as shown below, where L denotes filter length, f_{m,n} represents filter coefficient, and f(k,l) denotes the decoded filter coefficients.

R′(i,j)=Σ_{k=-L/2}^{L/2}Σ_{l=-L/2}^{L/2}f(k,l)×R(i+k,j+l) (10)

Alternatively, the filtering process of the Adaptive Loop Filter, could be expressed as follows:

O(x,y)=Σ_{(i,j)}w(i,j)·I(x+i,y+j), (11)

where samples I(x+i, y+j) are input samples, O(x, y) is the filtered output sample (i.e. filter result), and w(i, j) denotes the filter coefficients. In practice, in VTM4.0, it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) >> 7 , \qquad ( 12 )$$

where L denotes the filter length, and where w(i,j) are the filter coefficients in fixed point precision.

### 2.4. Non-Linear ALF

### 2.4.1. Filtering Reformulation

Equation (11) can be reformulated, without coding efficiency impact, in the following expression:

O(x,y)=I(x,y)+Σ_{(i,j)≠(0,0)}w(i,j)·(I(x+i,y+j)−I(x,y)), (13)

where w(i,j) are the same filter coefficients as in equation ( ) [excepted w(0,0) which is equal to 1 in equation (13) while it is equal to 1−Σ_{(i,j)≠(0,0)}w(i,j) in equation (11)].

### 2.4.2. Modified Filter

Using this above filter formula of (13), we can easily introduce non linearity to make ALF more efficient by using a simple clipping function to reduce the impact of neighbor sample values (I(x+i,y+j)) when they are too different with the current sample value (I(x,y)) being filtered.

In this proposal, the ALF filter is modified as follows:

O′(x,y)=I(x,y)+Σ_{(i,j)≠(0,0)}w(i,j)·K(I(x+y+j)−I(x,y),k(i,j)), (14)

where K(d,b)=min (b, max(−b,d)) is the clipping function, and k(i,j) are clipping parameters, which depends on the (i,j) filter coefficient. The encoder performs the optimization to find the best k(i,j).

For easy implementation, the filter coefficient w(i,j) is stored and used in integer precision. The above equation could be rewritten as follows:

O′(i,j)=I(i,j)+((Σ_{k≠0}Σ_{l≠0}w(k,l)×K(I(i+k,j+l)−c(k,l))+64)»7) (15)

where w(k,l) denotes the decoded filter coefficients, K(x,y) is the clipping function and c(k,l) denotes the decoded clipping parameters. The variable k and l varies between

$$- \frac{L}{2} and \frac{L}{2}$$

where L denotes the filter length. The clipping function K(x,y)=min (y, max(−y,x)) which corresponds to the function Clip3 (−y,y,x).

In the JVET-N0242 implementation, the clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, we limit the evaluation of the clipping values to a small set of possible values. In the proposal, we only use 4 fixed values which are the same for INTER and INTRA tile groups.

Because the variance of the local differences is often higher for Luma than for Chroma, we use two different sets for the Luma and Chroma filters. We also include the maximum sample value (here 1024 for 10 bits bit-depth) in each set, so that clipping can be disabled if it is not necessary.

The sets of clipping values used in the JVET-N0242 tests are provided in the Table 2. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 .. N ] \} ,$$

with M=2¹⁰ and N=4. (16)

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 .. N ] \} , with M = {2}^{10} , N = 4 and A = 4. \qquad ( 17 )$$

TABLE 2
Authorized clipping values

| | INTRA/INTER slices |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 2. This encoding scheme is the same as the encoding scheme for the filter index.

### 2.5. Virtual Boundary

In hardware and embedded software, picture-based processing is practically unacceptable due to its high picture buffer requirement. Using on-chip picture buffers is very expensive and using off-chip picture buffers significantly increases external memory access, power consumption, and data access latency. Therefore, DF, SAO, and ALF will be changed from picture-based to LCU-based decoding in real products. When LCU-based processing is used for DF, SAO, and ALF, the entire decoding process can be done LCU by LCU in a raster scan with an LCU-pipelining fashion for parallel processing of multiple LCUs. In this case, line buffers are required for DF, SAO, and ALF because processing one LCU row requires pixels from the above LCU row. If off-chip line buffers (e.g. DRAM) are used, the external memory bandwidth and power consumption will be increased; if on-chip line buffers (e.g. SRAM) are used, the chip area will be increased. Therefore, although line buffers are already much smaller than picture buffers, it is still desirable to reduce line buffers.

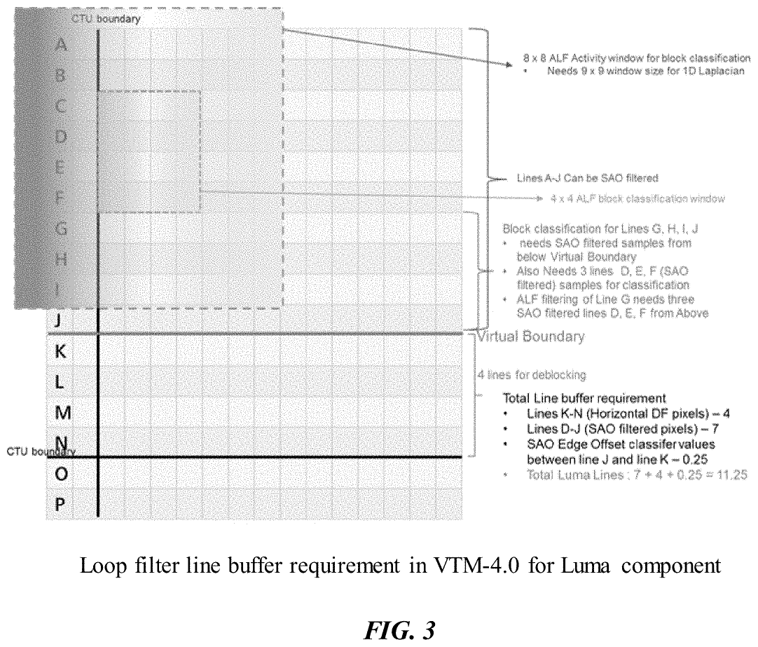

In VTM-4.0, as shown in FIG. 3, the total number of line buffers required is 11.25 lines for the Luma component. The explanation of the line buffer requirement is as follows: The deblocking of horizontal edge overlapping with CTU edge cannot be performed as the decisions and filtering require lines K, L, M, M from the first CTU and Lines O, P from the bottom CTU. Therefore, the deblocking of the horizontal edges overlapping with the CTU boundary is postponed until the lower CTU comes. Therefore for the lines K, L, M, N reconstructed luma samples have to be stored in the line buffer (4 lines). Then the SAO filtering can be performed for lines A till J. The line J can be SAO filtered as deblocking does not change the samples in line K. For SAO filtering of line K, the edge offset classification decision is only stored in the line buffer (which is 0.25 Luma lines). The ALF filtering can only be performed for lines A-F. As shown in FIG. 3, the ALF classification is performed for each 4×4 block. Each 4×4 block classification needs an activity window of size 8×8 which in turn needs a 9×9 window to compute the 1d Laplacian to determine the gradient.

Therefore, for the block classification of the 4×4 block overlapping with lines G, H, I, J needs, SAO filtered samples below the Virtual boundary. In addition, the SAO filtered samples of lines D, E, F are required for ALF classification. Moreover, the ALF filtering of Line G needs three SAO filtered lines D, E, F from above lines. Therefore, the total line buffer requirement is as follows:
Lines K-N (Horizontal DF pixels): 4 lines
Lines D-J (SAO filtered pixels): 7 lines
SAO Edge offset classifier values between line J and line K: 0.25 line

Therefore, the total number of luma lines required is 7+4+0.25=11.25.

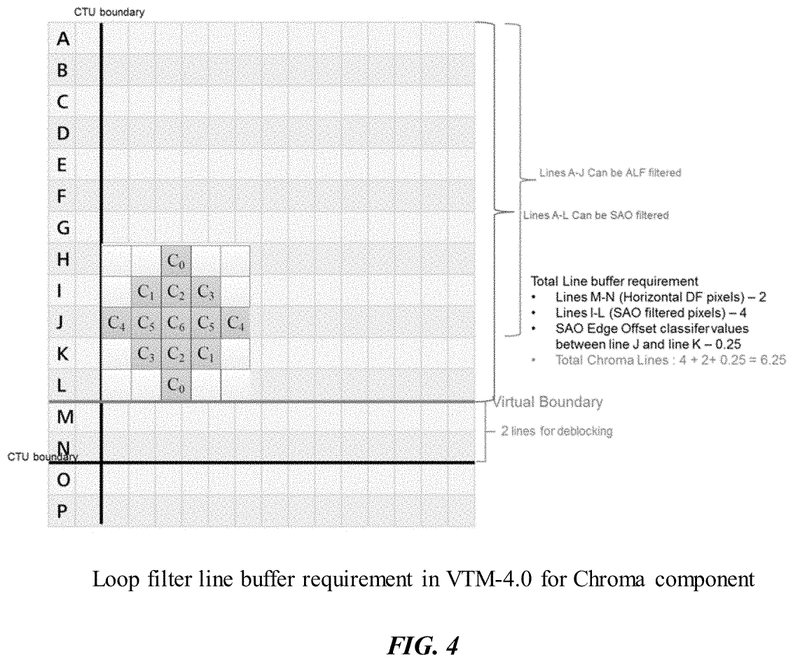

Similarly, the line buffer requirement of the Chroma component is illustrated in FIG. 4. The line buffer requirement for Chroma component is evaluated to be 6.25 lines.

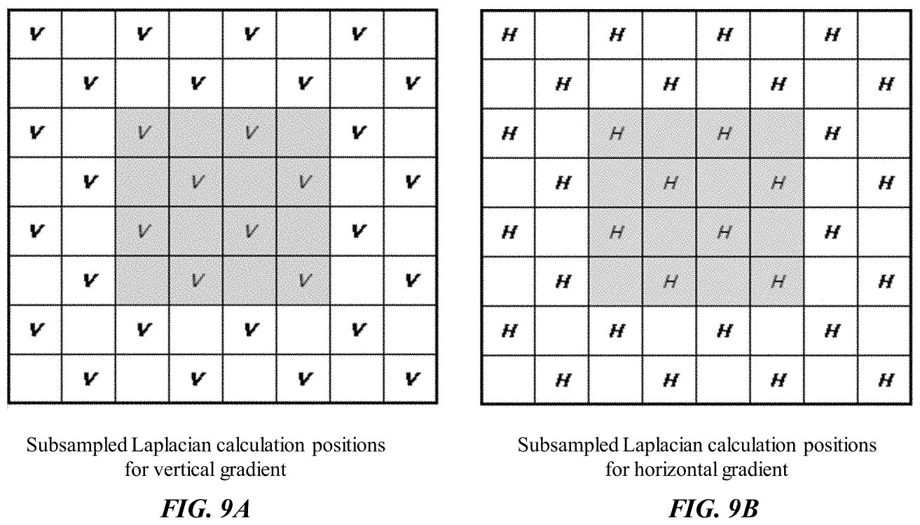

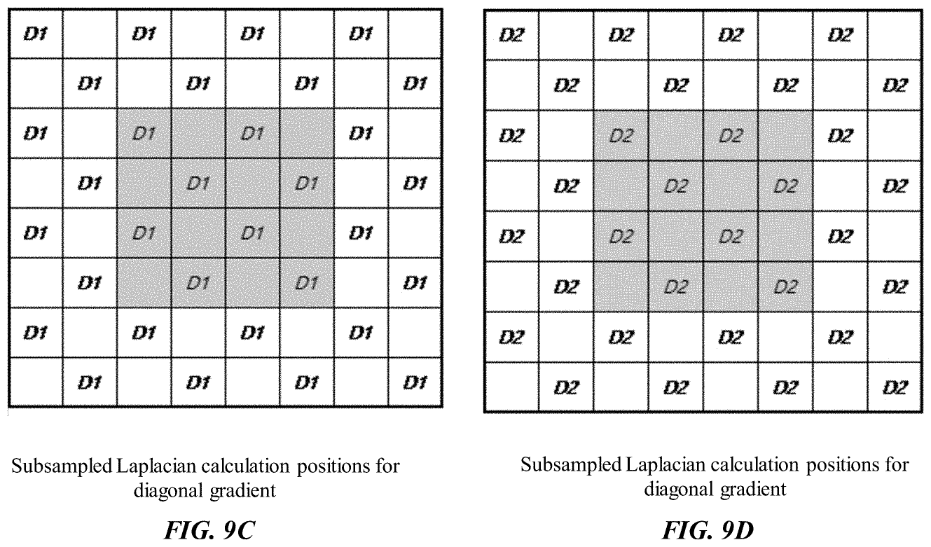

In order to eliminate the line buffer requirements of SAO and ALF, the concept of virtual boundary (VB) is introduced in the latest VVC. As shown in FIG. 3, VBs are upward shifted horizontal LCUboundaries by N pixels. For each LCU, SAO and ALF can process pixels above the VB before the lower LCU comes but cannot process pixels below the VB until the lower LCU comes, which is caused by DF. With consideration of the hardware implementation cost, the space between the proposed VB and the horizontal LCU boundary is set as four pixels for luma (i.e. N=4 in FIG. 3) and two pixels for chroma (i.e. N=2 in FIG. 9).

2.5.1. Modified ALF Block Classification when VB Size N is 4

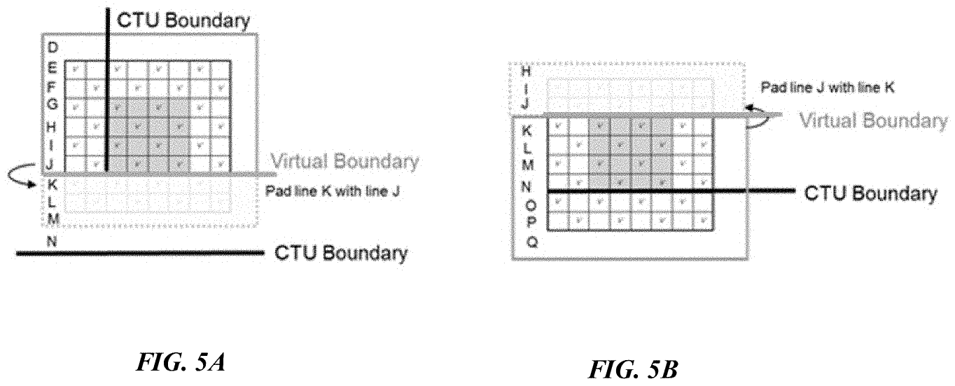

FIG. 5A and FIG. 5B depict modified block classification for the case when the virtual boundary is 4 lines above the CTU boundary (for N=4). FIG. 5A shows the classification for a 4×4 block starting at line G and FIG. 5B shows the classification for a 4×4 block starting at line K. As depicted in FIG. 5A, for the 4×4 block starting at line G, the block classification only uses the lines E till J. However Laplacian gradient calculation for the samples belonging to line J requires one more line below (line K). Therefore, line K is padded with line J.

Similarly, as depicted in FIG. 5B, for the 4×4 block starting at line K, the block classification only uses the lines K till P. However Laplacian gradient calculation for the samples belonging to line K require one more line above (line J). Therefore, line J is padded with line K.

### 2.5.2. Two-Side Padding for Samples Cross Virtual Boundaries

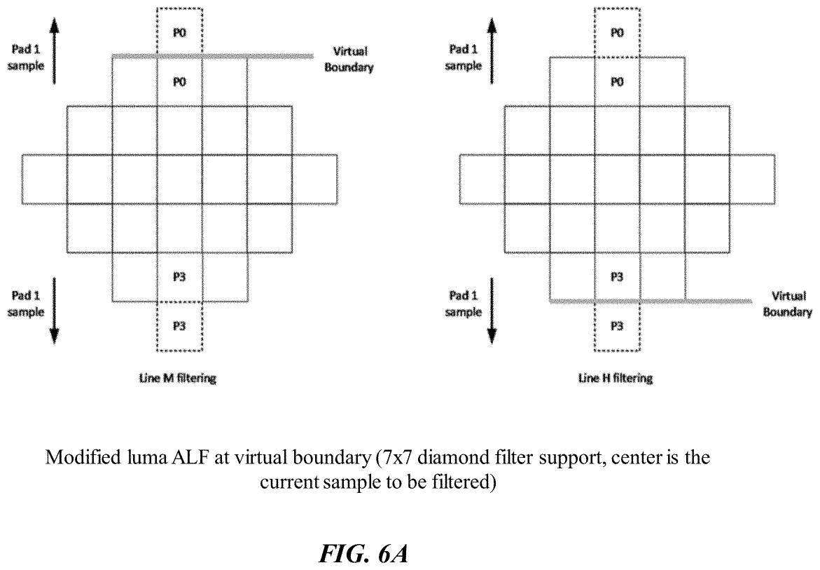

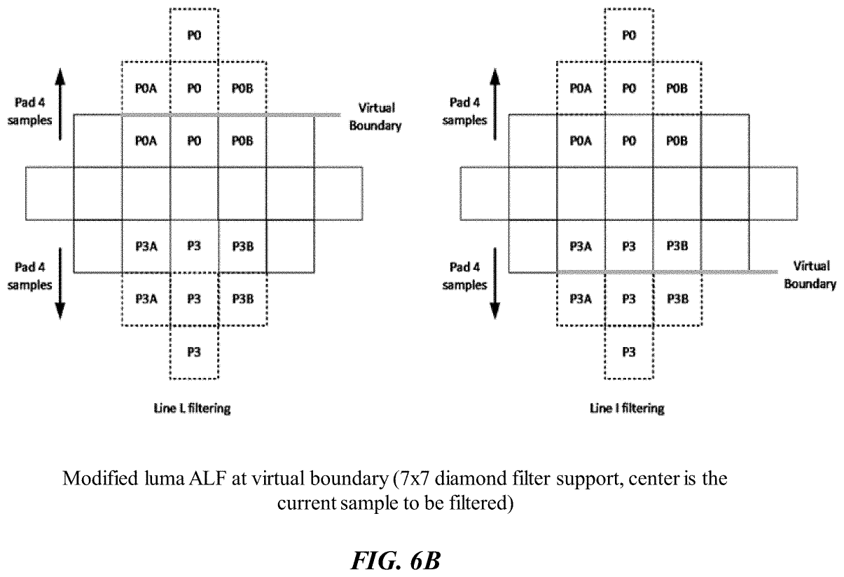

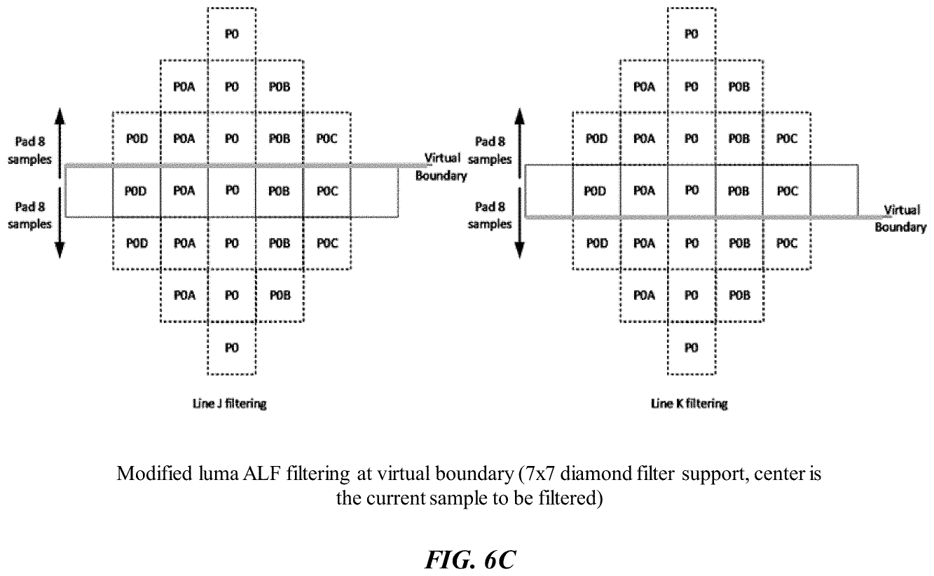

As depicted in FIGS. 6A to 6C, truncated version of the filters is used for filtering of the luma samples belonging to the lines close to the virtual boundaries. FIG. 6A shows one required line that is above/below a virtual boundary (VB) needs to be padded (per side), FIG. 6B shows two required lines that are above/below VB need to be padded (per side), and FIG. 6C shows three required lines that are above/below VB need to be padded (per side). In FIGS. 6A to 6C, the VB is denoted by the grey line. Taking FIG. 6A for example, when filtering the line M as denoted in FIG. 3, i.e., the center sample of the 7×7 diamond support is in the line M, it requires to access one line above the VB. In this case, the samples above the VB is copied from the right below sample below the VB, such as the PO sample in the solid line is copied to the above dash position. Symmetrically, P3 sample in the solid line is also copied to the right below dashed position even the sample for that position is available. The copied samples are only used in the luma filtering process.

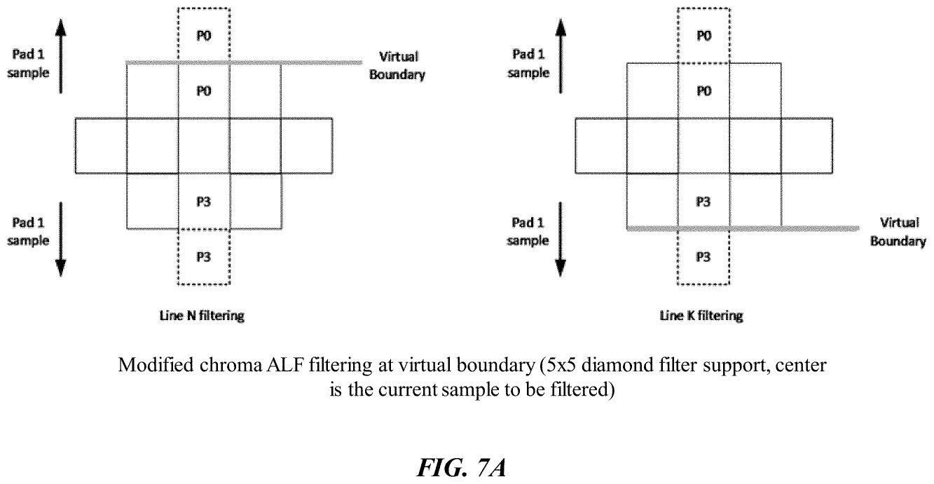

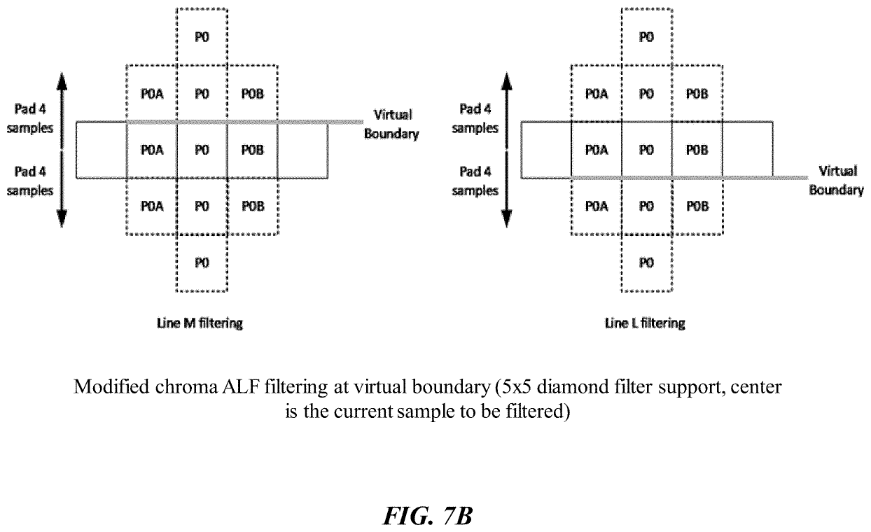

The padding method used for ALF virtual boundaries may be denoted as ‘Two-side Padding’ wherein if one sample located at (i, j) (e.g., the POA with dash line in FIG. 6B) is padded, then the corresponding sample located at (m, n) (e.g., the P3B with dash line in FIG. 6C) which share the same filter coefficient is also padded even the sample is available, as depicted in FIGS. 6A to 6C and FIGS. 7A to 7C.

Similarly, as depicted in FIGS. 7A to 7C, the two-side padding method is also used for chroma ALF filtering. FIG. 7A shows one required line that is above/below a virtual boundary (VB) needs to be padded (per side), and FIG. 7B shows two required lines that are above/below VB need to be padded (per side). In FIGS. 7A and 7B, the VB is denoted by the grey line.

2.5.3. Alternative Way for Implementation of the Two-Side Padding when Non-Linear ALF is Disabled

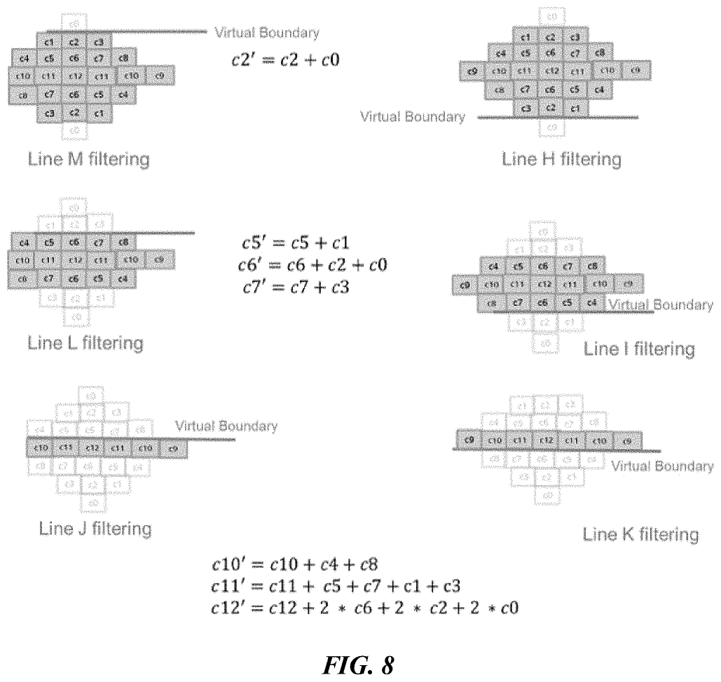

When the non-linear ALF is disabled for a CTB, e.g., the clipping parameters k (i, j) in equation (14) are equal to (1<<Bitdepth), the padding process could be replaced by modifying the filter coefficients (a.k.a modified-coeff based ALF, MALF). For example, when filtering samples in line L/I, the filter coefficient c5 is modified to c5′, in this case, there is no need to copy the luma samples from the solid POA to dashed POA and solid P3B to dashed P3B in FIG. 8. In this case, the two-side padding and MALF will generate the same results, assuming the current sample to be filtered is located at (x, y).

c5·K(I(x−1,y−1)−I(x,y),k(−1,−1))+c1·K(I(x−1,y−2)−I(x,y),k(−1,−2))=(c5+c1)·K(I(x−1,y−1)−I(x,y),k(−1,−1)) (18)

since K(d, b)=d and I(x−1,y−1)=/(x−1,y−2) due to padding.

However, when the non-linear ALF is enabled, MALF and two-side padding may generate different filtered results, since the non-linear parameters are associated with each coefficient, such as for filter coefficients c5 and c 1, the clipping parameters are different Therefore,

c5·K(I(x−1,y−1)−I(x,y),k(−1,−1))+c1·K(I(x−1,y−2)−I(x,y),k(−1,−2))!=(c5+c1)·K(I(x−1,y−1)−I(x,y),k(−1,−1)) (19)

since K(d, b)!=d, even I(x−1,y−1)=I(x−1, y−2) due to padding.

### 2.6. Geometry Transformation-Based Adaptive Loop Filter in VVC

The current design of GALF in VVC has the following major changes compared to that in JEM:
1) The adaptive filter shape is removed. Only 7×7 filter shape is allowed for luma component and 5×5 filter shape is allowed for chroma component.
2) ALF filter coefficients are signaled in ALF Adaptation Parameter Set (APS). 3) Non-linear ALF could be applied.
4) For each CTU, one bit flag for each color component is signaled whether ALF is enabled or disabled.
5) Calculation of class index is performed in 4×4 level instead of 2×2. In addition, as proposed in JVET-L0147, sub-sampled Laplacian calculation method for ALF classification is utilized. More specifically, there is no need to calculate the horizontal/vertical/45 diagonal/135 degree gradients for each sample within one block. Instead, 1:2 sub sampling is utilized.

### 2.7. Signaling of ALF Parameters in Adaptation Parameter Set

In the latest version of VVC draft, ALF parameters can be signaled in Adaptation Parameter Set (APS) and can be selected by each CTU adaptively. In one APS, up to 25 sets of luma filter coefficients and clipping value indexes, and up to eight sets of chroma filter coefficients and clipping value indexes could be signaled. To reduce bits overhead, filter coefficients of different classification for luma component can be merged. In slice header, the indices of the APSs used for the current slice are signaled.

The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

The detailed signaling of ALF (in JVET-P2001-v9) is as follows.

### 7.3.2.5 Adaptation Parameter Set Syntax

| | Descriptor |
|---|---|
| adaptation_parameter_set_rbsp( ) { | |
| adaptation_{—}parameter_{—}set_{—}id | u(5) |
| aps_{—}params_{—}type | u(3) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_{—}extension_{—}flag | u(1) |
| if( aps_extension_flag ) | |
| while( more_rbsp_data( ) ) | |
| aps_{—}extension_{—}data_{—}flag | u(1) |
| rbsp_trailing_bits( ) | |
| } | |

### 7.3.2.16 Adaptive Loop Filter Data Syntax

| | Descriptor |
|---|---|
| alf_data( ) { | |
| alf_{—}luma_{—}filter_{—}signal_{—}flag | u(1) |
| alf_{—}chroma_{—}filter_{—}signal_{—}flag | u(1) |
| if( alf_luma_filter_signal_flag ) { | |
| alf_{—}luma_{—}clip_{—}flag | u(1) |
| alf_{—}luma_{—}num_{—}filters_{—}signalled_{—}minus1 | ue(v) |
| if( alf_luma_num_filters_signalled_minus1 > 0 ) { | |
| for( filtIdx = 0; filtIdx < NumAlfFilters; filtIdx++ ) | |
| alf_{—}luma_{—}coeff_{—}delta_{—}idx[ filtIdx ] | u(v) |
| } | |
| alf_{—}luma_{—}coeff_{—}signalled_{—}flag | u(1) |
| if( alf_luma_coeff_signalled_flag ) { | |
| for( sfIdx = 0; sfIdx <= alf_luma_num_filters_signalled_minus1; sfIdx++ ) | |
| alf_{—}luma_{—}coeff_{—}flag[ sfIdx ] | u(1) |
| } | |
| for( sfIdx = 0; sfIdx <= alf_luma_num_filters_signalled_minus1; sfIdx++ ) { | |
| if( alf_luma_coeff_flag[ sfIdx ] ) { | |
| for ( j = 0; j < 12; j++ ) { | |
| alf_{—}luma_{—}coeff_{—}abs[ sfIdx ][ j ] | uek(v) |
| if( alf_luma_coeff_abs[ sfIdx ][ j ] ) | |
| alf_{—}luma_{—}coeff_{—}sign[ sfIdx ][ j ] | u(1) |
| } | |
| } | |
| } | |
| if( alf_luma_clip_flag ) { | |
| for( sfIdx = 0; sfIdx <= alf_luma_num_filters_signalled_minus1; sfIdx++ ) { | |
| if( alf_luma_coeff_flag[ sfIdx ] ) { | |
| for( j = 0; j < 12; j++ ) | |
| alf_{—}luma_{—}clip_{—}idx[ sfIdx ][ j ] | u(2) |
| } | |
| } | |
| } | |
| } | |
| if( alf_chroma_filter_signal_flag ) { | |
| alf_{—}chroma_{—}num_{—}alt_{—}filters_{—}minus1 | ue(v) |
| for( altIdx = 0; altIdx <= alf_chroma_num_alt_filters_minus1; altIdx++ ) { | |
| alf_{—}chroma_{—}clip_{—}flag[ altIdx ] | u(1) |
| for( j = 0; j < 6; j++ ) { | |
| alf_{—}chroma_{—}coeff_{—}abs[ altIdx ][ j ] | uek(v) |
| if( alf_chroma_coeff_abs[ altIdx ][ j ] > 0 ) | |
| alf_{—}chroma_{—}coeff_{—}sign[ altIdx ][ j ] | u(1) |
| } | |
| if( alf_chroma_clip_flag[ altIdx ] ) { | |
| for( j = 0; j < 6; j++ ) | |
| alf_{—}chroma_{—}clip_{—}idx[ altIdx ][ j ] | u(2) |
| } | |
| } | |
| } | |
| } | |

### 7.4.3.5 Adaptation Parameter Set Semantics

Each APS RBSP shall be available to the decoding process prior to it being referred, included in at least one access unit with TemporalId less than or equal to the TemporalId of the coded slice NAL unit that refers it or provided through external means.

Let aspLayerIld be the nuh_layer_id of an APS NAL unit. If the layer with nuh_layer_id equal to aspLayerIld is an independent layer (i.e., vps_independent_layer_flag[GeneralLayerIdx[aspLayerIld]] is equal to 1), the APS NAL unit containing the APS RBSP shall have nuh_layer_id equal to the nuh_layer_id of a coded slice NAL unit that refers it. Otherwise, the APS NAL unit containing the APS RBSP shall have nuh_layer_id either equal to the nuh_layer_id of a coded slice NAL unit that refers it, or equal to the nuh_layer_id of a direct dependent layer of the layer containing a coded slice NAL unit that refers it.

All APS NAL units with a particular value of adaptation_parameter_set_id and a particular value of aps_params_type within an access unit shall have the same content.

adaptation_parameter_set_id provides an identifier for the APS for reference by other syntax elements.

When aps_params_type is equal to ALF_APS or SCALING_APS, the value of adaptation_parameter_set_id shall be in the range of 0 to 7, inclusive.

When aps_params_type is equal to LMCS_APS, the value of adaptation_parameter_set_id shall be in the range of 0 to 3, inclusive.

aps_params_type specifies the type of APS parameters carried in the APS as specified in Table 3. When aps_params_type is equal to 1 (LMCS_APS), the value of adaptation_parameter_set_id shall be in the range of 0 to 3, inclusive.

TABLE 3
APS parameters type codes and types of APS parameters

| | Name of | |
|---|---|---|
| aps_params_type | aps_params_type | Type of APS parameters |
| 0 | ALF_APS | ALF parameters |
| 1 | LMCS_APS | LMCS parameters |
| 2 | SCALING_APS | Scaling list parameters |
| 3 . . . 7 | Reserved | Reserved |

NOTE 1
Each type of APSs uses a separate value space for adaptation_parameter_set_id.
NOTE 2
An APS NAL unit (with a particular value of adaptation_parameter_set_id and a particular value of aps_params_type) can be shared across pictures, and different slices within a picture can refer to different ALF APSs.

aps_extension_flag equal to 0 specifies that no aps_extension_data_flag syntax elements are present in the APS RBSP syntax structure. aps_extension_flag equal to 1 specifies that there are aps_extension_data_flag syntax elements present in the APS RBSP syntax structure.

aps_extension_data_flag may have any value. Its presence and value do not affect decoder conformance to profiles specified in this version of this Specification. Decoders conforming to this version of this Specification shall ignore all aps_extension_data_flag syntax elements.

### 7.4.3.14 Adaptive Loop Filter Data Semantics

alf_luma_filter_signal_flag equal to 1 specifies that a luma filter set is signalled. alf_luma_filter_signal_flag equal to 0 specifies that a luma filter set is not signalled. alf_chroma_filter_signal_flag equal to 1 specifies that a chroma filter is signalled. alf_chroma_filter_signal_flag equal to 0 specifies that a chroma filter is not signalled. When ChromaArrayType is equal to 0, alf_chroma_filter_signal_flag shall be equal to 0. The variable NumAlfFilters specifying the number of different adaptive loop filters is set equal to 25.

alf_luma_clip_flag equal to 0 specifies that linear adaptive loop filtering is applied on luma component. alf_luma_clip_flag equal to 1 specifies that non-linear adaptive loop filtering may be applied on luma component.

alf_luma_num_filters_signalled_minus1 plus 1 specifies the number of adaptive loop filter classes for which luma coefficients can be signalled. The value of

alf_luma_num_filters_signalled_minus1 shall be in the range of 0 to NumAlfFilters−1, inclusive.

alf_luma_coeff_delta_idx[filtIdx] specifies the indices of the signalled adaptive loop filter luma coefficient deltas for the filter class indicated by filtIdx ranging from 0 to NumAlfFilters−1. When alf_luma_coeff_delta_idx[filtIdx] is not present, it is inferred to be equal to 0. The length of alf_luma_coeff_delta_idx[filtIdx] is Ceil(Log2(alf_luma_num_filters_signalled_minus1+1)) bits.

alf_luma_coeff_signalled_flag equal to 1 indicates that alf_luma_coeff_flag[sfIdx] is signalled. alf_luma_coeff_signalled flag equal to 0 indicates that alf_luma_coeff_flag[sfIdx] is not signalled.

alf_luma_coeff_flag[sfIdx] equal 1 specifies that the coefficients of the luma filter indicated by sfIdx are signalled. alf_luma_coeff_flag[sfIdx] equal to 0 specifies that all filter coefficients of the luma filter indicated by sfIdx are set equal to 0. When not present, alf_luma_coeff_flag[sfIdx] is set equal to 1.

alf_luma_coeff_abs[sfIdx][j] specifies the absolute value of the j-th coefficient of the signalled luma filter indicated by sfIdx. When alf_luma_coeff_abs[sfIdx][j] is not present, it is inferred to be equal 0.

The order k of the exp-Golomb binarization uek(v) is set equal to 3.

alf_luma_coeff_sign[sfIdx][j] specifies the sign of the j-th luma coefficient of the filter indicated by sfIdx as follows:
If alf_luma_coeff_sign[sfIdx][j] is equal to 0, the corresponding luma filter coefficient has a positive value.
Otherwise (alf_luma_coeff_sign[sfIdx][j] is equal to 1), the corresponding luma filter coefficient has a negative value.

When alf_luma_coeff_sign[sfIdx][j] is not present, it is inferred to be equal to 0.

The variable filtCoeff[sfIdx][j] with sfIdx=0 . . . alf_luma_num_filters_signalled_minus1,j=0 . . . 11 is initialized as follows:

filtCoeff[sfIdx][j]=alf_luma_coeff_abs[sfIdx][j]*(1−2*alf_luma_coeff_sign[sfIdx][j]) (7-47)

The luma filter coefficients AlfCoeff_{L}[adaptation_parameter_set_id] with elements AlfCoeff_{L}[adaptation_parameter_set_id][filtIdx][j], with filtIdx=0 . . . NumAlfFilters−1 and j=0 . . . 11 are derived as follows:

AlfCoeff_{L}[adaptation_parameter_set_id][filtIdx][j]=filtCoeff[alf_luma_coeff_delta_idx[filtIdx]][j] (7-48)

The fixed filter coefficients AlfFixFiltCoeff[i][j] with i=0 . . . 64, j=0 . . . 11 and the class to filter mapping AlfClassToFiltMap[m][n] with m=0 . . . 15 and n=0 . . . 24 are derived as follows:

| | |
|---|---|
| AlfFixFiltCoeff = | (7-49) |

```
  {
    { 0, 0, 2, −3, 1, −4, 1, 7, −1, 1, −1, 5}
    { 0, 0, 0, 0, 0, −1, 0, 1, 0, 0, −1, 2}
    { 0, 0, 0, 0, 0, 0, 0, 1, 0, 0, 0, 0}
    { 0, 0, 0, 0, 0, 0, 0, 0, 0, 0, −1, 1}
    { 2, 2, −7, −3, 0, −5, 13, 22, 12, −3, −3, 17}
    {−1, 0, 6, −8, 1, −5, 1, 23, 0, 2, −5, 10}
    { 0, 0, −1, −1, 0, −1, 2, 1, 0, 0, −1, 4}
    { 0, 0, 3, −11, 1, 0, −1, 35, 5, 2, −9, 9}
    { 0, 0, 8, −8, −2, −7, 4, 4, 2, 1, −1, 25}
    { 0, 0, 1, −1, 0, −3, 1, 3, −1, 1, −1, 3}
    { 0, 0, 3, −3, 0, −6, 5, −1, 2, 1, −4, 21}
    {−7, 1, 5, 4, −3, 5, 11, 13, 12, −8, 11, 12}
    {−5, −3, 6, −2, −3, 8, 14, 15, 2, −7, 11, 16}
    { 2, −1, −6, −5, −2, −2, 20, 14, −4, 0, −3, 25}
    { 3, 1, −8, −4, 0, −8, 22, 5, −3, 2, −10, 29}
    { 2, 1, −7, −1, 2, −11, 23, −5, 0, 2, −10, 29}
    {−6, −3, 8, 9, −4, 8, 9, 7, 14, −2, 8, 9}
    { 2, 1, −4, −7, 0, −8, 17, 22, 1, −1, −4, 23}
    { 3, 0, −5, −7, 0, −7, 15, 18, −5, 0, −5, 27}
    { 2, 0, 0, −7, 1, −10, 13, 13, −4, 2, −7, 24}
    { 3, 3, −13, 4, −2, −5, 9, 21, 25, −2, −3, 12}
    {−5, −2, 7, −3, −7, 9, 8, 9, 16, −2, 15, 12}
    { 0, −1, 0, −7, −5, 4, 11, 11, 8, −6, 12, 21}
    { 3, −2, −3, −8, −4, −1, 16, 15, −2, −3, 3, 26}
    { 2, 1, −5, −4, −1, −8, 16, 4, −2, 1, −7, 33}
    { 2, 1, −4, −2, 1, −10, 17, −2, 0, 2, −11, 33}
    { 1, −2, 7, −15, −16, 10, 8, 8, 20, 11, 14, 11}
    { 2, 2, 3, −13, −13, 4, 8, 12, 2, −3, 16, 24}
    { 1, 4, 0, −7, −8, −4, 9, 9, −2, −2, 8, 29}
    { 1, 1, 2, −4, −1, −6, 6, 3, −1, −1, −3, 30}
    {−7, 3, 2, 10, −2, 3, 7, 11, 19, −7, 8, 10}
    { 0, −2, −5, −3, −2, 4, 20, 15, −1, −3, −1, 22}
    { 3, −1, −8, −4, −1, −4, 22, 8, −4, 2, −8, 28}
    { 0, 3, −14, 3, 0, 1, 19, 17, 8, −3, −7, 20}
    { 0, 2, −1, −8, 3, −6, 5, 21, 1, 1, −9, 13}
    {−4, −2, 8, 20, −2, 2, 3, 5, 21, 4, 6, 1}
    { 2, −2, −3, −9, −4, 2, 14, 16, 3, −6, 8, 24}
    { 2, 1, 5, −16, −7, 2, 3, 11, 15, −3, 11, 22}
    { 1, 2, 3, −11, −2, −5, 4, 8, 9, −3, −2, 26}
    { 0, −1, 10, −9, −1, −8, 2, 3, 4, 0, 0, 29}
    { 1, 2, 0, −5, 1, −9, 9, 3, 0, 1, −7, 20}
    {−2, 8, −6, −4, 3, −9, −8, 45, 14, 2, −13, 7}
    { 1, −1, 16, −19, −8, −4, −3, 2, 19, 0, 4, 30}
    { 1, 1, −3, 0, 2, −11, 15, −5, 1, 2, −9, 24}
    { 0, 1, −2, 0, 1, −4, 4, 0, 0, 1, −4, 7}
    { 0, 1, 2, −5, 1, −6, 4, 10, −2, 1, −4, 10}
    { 3, 0, −3, −6, −2, −6, 14, 8, −1, −1, −3, 31}
    { 0, 1, 0, −2, 1, −6, 5, 1, 0, 1, −5, 13}
    { 3, 1, 9, −19, −21, 9, 7, 6, 13, 5, 15, 21}
    { 2, 4, 3, −12, −13, 1, 7, 8, 3, 0, 12, 26}
    { 3, 1, −8, −2, 0, −6, 18, 2, −2, 3, −10, 23}
    { 1, 1, −4, −1, 1, −5, 8, 1, −1, 2, −5, 10}
    { 0, 1, −1, 0, 0, −2, 2, 0, 0, 1, −2, 3}
    { 1, 1, −2, −7, 1, −7, 14, 18, 0, 0, −7, 21}
    { 0, 1, 0, −2, 0, −7, 8, 1, −2, 0, −3, 24}
    { 0, 1, 1, −2, 2, −10, 10, 0, −2, 1, −7, 23}
    { 0, 2, 2, −11, 2, −4, −3, 39, 7, 1, −10, 9}
    { 1, 0, 13, −16, −5, −6, −1, 8, 6, 0, 6, 29}
    { 1, 3, 1, −6, −4, −7, 9, 6, −3, −2, 3, 33}
    { 4, 0, −17, −1, −1, 5, 26, 8, −2, 3, −15, 30}
    { 0, 1, −2, 0, 2, −8, 12, −6, 1, 1, −6, 16}
    { 0, 0, 0, −1, 1, −4, 4, 0, 0, 0, −3, 11}
    { 0, 1, 2, −8, 2, −6, 5, 15, 0, 2, −7, 9}
    { 1, −1, 12, −15, −7, −2, 3, 6, 6, −1, 7, 30}
  },
```

| | |
|---|---|
| AlfClassToFiltMap = | (7-50) |

```
  {
    { 8, 2, 2, 2, 3, 4, 53, 9, 9, 52, 4, 4, 5, 9, 2, 8, 10, 9, 1, 3, 39, 39, 10, 9, 52 }
    { 11, 12, 13, 14, 15, 30, 11, 17, 18, 19, 16, 20, 20, 4, 53, 21, 22, 23, 14, 25, 26, 26, 27, 28, 10 }
    { 16, 12, 31, 32, 14, 16, 30, 33, 53, 34, 35, 16, 20, 4, 7, 16, 21, 36, 18, 19, 21, 26, 37, 38, 39 }
    { 35, 11, 13, 14, 43, 35, 16, 4, 34, 62, 35, 35, 30, 56, 7, 35, 21, 38, 24, 40, 16, 21, 48, 57, 39 }
    { 11, 31, 32, 43, 44, 16, 4, 17, 34, 45, 30, 20, 20, 7, 5, 21, 22, 46, 40, 47, 26, 48, 63, 58, 10 }
    { 12, 13, 50, 51, 52, 11, 17, 53, 45, 9, 30, 4, 53, 19, 0, 22, 23, 25, 43, 44, 37, 27, 28, 10, 55 }
    { 30, 33, 62, 51, 44, 20, 41, 56, 34, 45, 20, 41, 41, 56, 5, 30, 56, 38, 40, 47, 11, 37, 42, 57, 8 }
    { 35, 11, 23, 32, 14, 35, 20, 4, 17, 18, 21, 20, 20, 20, 4, 16, 21, 36, 46, 25, 41, 26, 48, 49, 58 }
    { 12, 31, 59, 59, 3, 33, 33, 59, 59, 52, 4, 33, 17, 59, 55, 22, 36, 59, 59, 60, 22, 36, 59, 25, 55 }
    { 31, 25, 15, 60, 60, 22, 17, 19, 55, 55, 20, 20, 53, 19, 55, 22, 46, 25, 43, 60, 37, 28, 10, 55, 52 }
    { 12, 31, 32, 50, 51, 11, 33, 53, 19, 45, 16, 4, 4, 53, 5, 22, 36, 18, 25, 43, 26, 27, 27, 28, 10 }
    { 5, 2, 44, 52, 3, 4, 53, 45, 9, 3, 4, 56, 5, 0, 2, 5, 10, 47, 52, 3, 63, 39, 10, 9, 52 }
    { 12, 34, 44, 44, 3, 56, 56, 62, 45, 9, 56, 56, 7, 5, 0, 22, 38, 40, 47, 52, 48, 57, 39, 10, 9 }
    { 35, 11, 23, 14, 51, 35, 20, 41, 56, 62, 16, 20, 41, 56, 7, 16, 21, 38, 24, 40, 26, 26, 42, 57, 39 }
    { 33, 34, 51, 51, 52, 41, 41, 34, 62, 0, 41, 41, 56, 7, 5, 56, 38, 38, 40, 44, 37, 42, 57, 39, 10 }
    { 16, 31, 32, 15, 60, 30, 4, 17, 19, 25, 22, 20, 4, 53, 19, 21, 22, 46, 25, 55, 26, 48, 63, 58, 55 }
  },
```

It is a requirement of bitstream conformance that the values of AlfCoeff_{L}[adaptation_parameter_set_id][filtIdx][j] with filtIdx=0 . . . NumAlfFilters−1, j=0 . . . 11 shall be in the range of −2⁷ to 2⁷−1, inclusive.

alf_luma_clip_idx[sfIdx][j] specifies the clipping index of the clipping value to use before multiplying by the j-th coefficient of the signalled luma filter indicated by sfIdx. It is a requirement of bitstream conformance that the values of alf_luma_clip_idx[sfIdx][j] with sfIdx=0 . . . alf_luma_num_filters_signalled_minus1 and j=0 . . . 11 shall be in the range of 0 to 3, inclusive.

The luma filter clipping values AlfClip_{L}[adaptation_parameter_set_id] with elements AlfClip_{L}[adaptation_parameter_set_id][filtIdx][j], with filtIdx=0 . . . NumAlfFilters−1 and j=0 . . . 11 are derived as specified in Table 4 depending on bitDepth set equal to BitDepth_{Y} and clipIdx set equal to alf_luma_clip_idx[alf_luma_coeff_delta_idx[filtIdx]][j].

alf_chroma_num_alt_filters_minus1 plus 1 specifies the number of alternative filters for chroma components.

alf_chroma_clip_flag[altIdx] equal to 0 specifies that linear adaptive loop filtering is applied on chroma components when using the chroma filter with index altIdx; alf_chroma_clip_flag[altIdx] equal to 1 specifies that non-linear adaptive loop filtering is applied on chroma components when using the chroma filter with index altIdx. When not present, alf_chroma_clip_flag[altIdx] is inferred to be equal to 0.

alf_chroma_coeff_abs[altIdx][j] specifies the absolute value of the j-th chroma filter coefficient for the alternative chroma filter with index altIdx. When alf_chroma_coeff_abs[altIdx][j] is not present, it is inferred to be equal 0. It is a requirement of bitstream conformance that the values of alf_chroma_coeff_abs[altIdx][j] shall be in the range of 0 to 2⁷−1, inclusive. The order k of the exp-Golomb binarization uek(v) is set equal to 3.

alf_chroma_coeff_sign[altIdx][j] specifies the sign of the j-th chroma filter coefficient for the alternative chroma filter with index altIdx as follows:
If alf_chroma_coeff_sign[altIdx][j] is equal to 0, the corresponding chroma filter coefficient has a positive value.
Otherwise (alf_chroma_coeff_sign[altIdx][j] is equal to 1), the corresponding chroma filter coefficient has a negative value.

When alf_chroma_coeff_sign[altIdx][j] is not present, it is inferred to be equal to 0.

The chroma filter coefficients AlfCoeff_{C}[adaptation_parameter_set_id][altIdx] with elements AlfCoeff_{C}[adaptation_parameter_set_id][altIdx][j], with altIdx 0 . . . alf_chroma_num_alt_filters_minus1, j=0 . . . 5 are derived as follows:

AlfCoeff_{C}[adaptation_pammeter_set_id][altIdx][j]=alf_chroma_coeff_abs[altIdx][j]*(1−2*alfchromacoeff_sign[altIdx][j]) (7-51)

It is a requirement of bitstream conformance that the values of AlfCoeff_{C}[adaptation_parameter_set_id][altIdx][j] with altIdx=0 . . . alf_chroma_num_alt_filters_minus1, j=0 . . . 5 shall be in the range of −2⁷−1 to 2⁷−1, inclusive.

alf_chroma_clip_idx[altIdx][j] specifies the clipping index of the clipping value to use before multiplying by the j-th coefficient of the alternative chroma filter with index altIdx. It is a requirement of bitstream conformance that the values of alf_chroma_clip_idx[altIdx][j] with altIdx=0 . . . alf_chroma_num_alt_filters_minus1, j=0 . . . 5 shall be in the range of 0 to 3, inclusive. The chroma filter clipping values AlfClip_{C}[adaptation_parameter_set_id][altIdx] with elements AlfClip_{C}[adaptation_parameter_set_id][altIdx][j], with altIdx=0 . . . alf_chroma_num_alt_filters_minus1, j=0 . . . 5 are derived as specified in Table 4 depending on bitDepth set equal to BitDepth_{C} and clipIdx set equal to alf_chroma_clip_idx[altIdx][j].

TABLE 4
Specification AlfClip depending on bitDepth and clipIdx

clipIdx

| bitDepth | 0 | 1 | 2 | 3 |
|---|---|---|---|---|
| 8 | 255 | 64 | 16 | 4 |
| 9 | 511 | 108 | 23 | 5 |
| 10 | 1023 | 181 | 32 | 6 |
| 11 | 2047 | 304 | 45 | 7 |
| 12 | 4095 | 512 | 64 | 8 |
| 13 | 8191 | 861 | 91 | 10 |
| 14 | 16383 | 1448 | 128 | 11 |
| 15 | 32767 | 2435 | 181 | 13 |
| 16 | 65535 | 4096 | 256 | 16 |

### 2.8. Signaling of ALF Parameters for a CTU

In the VTM6, ALF filter parameters are signalled in Adaptation Parameter Set (APS). In one APS, up to 25 sets of luma filter coefficients and clipping value indexes, and up to 8 sets of chroma filter coefficients and clipping value indexes could be signalled. To reduce bits overhead, filter coefficients of different classification for luma component can be merged. In slice header, the indices of the APSs used for the current slice are signaled.

Clipping value indexes, which are decoded from the APS, allow determining clipping values using a Luma table of clipping values and a Chroma table of clipping values. These clipping values are dependent of the internal bitdepth.

In slice header, up to 7 APS indices can be signaled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signaled for a luma CTB to indicate which filter set is applied. The 16 fixed filter sets are predefined and hard-coded in both the encoder and the decoder.

For chroma component, an APS index is signaled in slice header to indicate the chroma filter sets being used for the current slice. At CTB level, a filter index is signaled for each chroma CTB if there is more than one chroma filter set in the APS.

More specifically, the followings apply:

Slice on/off control flags are firstly coded to indicate whether at least one CTU in the slice applies ALF. When it is true, for each CTU, the following are checked and signaled in order:

The bolded, underlined text indicates proposed changes to the existing standard.

### Related to Luma Part:

1. Whether ALF is applied to the luma CTB. If yes, go to step 2. Otherwise, no further signaling is needed.
2. Check the number of ALF APS used for current slice, denote it by numALFAPS.
3. If numALFAPS is equal to 0, index of fixed filter (e.g., alf_luma_fixed_filter_idx) is signaled. Otherwise, the following apply:
   signal a flag to indicate whether it is predicted from the first ALF APS or not.
   If not, go to step 4. Otherwise, signaling of ALF parameters for the luma CTB is stopped.
4. If numALFAPS is greater than 1, signal a flag to indicate whether it is predicted from ALF APS or not.
   If not, signal the index of fixed filters;
   If yes and numALFAPS is greater than 2, signal the index of ALF APS minus 1 with truncated unary.

### Related to Chroma Part:

1. Whether ALF is applied to the Cb/Cr CTB. If yes, go to step 2. Otherwise, no further signaling is needed.
2. Signal the index of a filter associated with the i-th ALF APS wherein the APS index is signaled in slice header.

### 7.3.8.2 Coding Tree Unit Syntax

| | Descriptor |
|---|---|
| coding_tree_unit( ) { | |
| xCtb = ( CtbAddrInRs % PicWidthInCtbsY ) << CtbLog2SizeY | |
| yCtb = ( CtbAddrInRs / PicWidthInCtbsY ) << CtbLog2SizeY | |
| if( slice_sao_luma_flag \|\| slice_sao_chroma_flag ) | |
| sao( xCtb >> CtbLog2SizeY, yCtb >> CtbLog2SizeY ) | |
| if( slice_{—}alf_{—}enabled_{—}flag ){ | |
| alf_{—}ctb_{—}flag[ 0 ][ xCtb >> CtbLog2SizeY ][ yCtb >> CtbLog2SizeY ] | ae(v) |
| if( alf_{—}ctb_{—}flag[ 0 ][ xCtb >> CtbLog2SizeY ][ yCtb >> CtbLog2SizeY ] ) { | |
| if( slice_{—}num_{—}alf_{—}aps_{—}ids_{—}luma > 0 ) | |
| alf_{—}ctb_{—}use_{—}first_{—}aps_{—}flag | ae(v) |
| if( !alf_{—}ctb_{—}use_{—}first_{—}aps_{—}flag ) { | |
| if( slice_{—}num_{—}alf_{—}aps_{—}ids_{—}luma > 1 ) | |
| alf_{—}use_{—}aps_{—}flag | ae(v) |
| if( alf_{—}use_{—}aps_{—}flag ) { | |
| if( slice_{—}num_{—}alf_{—}aps_{—}ids_{—}luma > 2 ) | |
| alf_{—}luma_{—}prev_{—}filter_{—}idx_{—}minus1 | ae(v) |
| } else | |
| alf_{—}luma_{—}fixed_{—}filter_{—}idx | ae(v) |
| } | |
| } | |
| if( slice_{—}alf_{—}chroma_{—}idc = = 1 \|\| slice_{—}alf_{—}chroma_{—}idc = = 3 ) { | |
| alf_{—}ctb_{—}flag[ 1 ][ xCtb >> CtbLog2SizeY ][ yCtb >> CtbLog2SizeY ] | ae(v) |
| if( alf_{—}ctb_{—}flag[ 1 ][ xCtb >> CtbLog2SizeY ][ yCtb >> CtbLog2SizeY ] | |
| && aps_{—}alf_{—}chroma_{—}num_{—}alt_{—}filters_{—}minus1 > 0 ) | |
| alf_{—}ctb_{—}filter_{—}alt_{—}idx[ 0 ][ xCtb >> CtbLog2SizeY ][ yCtb >> CtbLog2SizeY ] | ae(v) |
| } | |
| if( slice_{—}alf_{—}chroma_{—}idc = = 2 \|\| slice_{—}alf_{—}chroma_{—}idc = = 3 ) { | |
| alf_{—}ctb_{—}flag[ 2 ][ xCtb >> CtbLog2SizeY ][ yCtb >> CtbLog2SizeY ] | ae(v) |
| if( alf_{—}ctb_{—}flag[ 2 ][ xCtb >> CtbLog2SizeY ][ yCtb >> CtbLog2SizeY ] | |
| && aps_{—}alf_{—}chroma_{—}num_{—}alt_{—}filters_{—}minus1 > 0 ) | |
| alf_{—}ctb_{—}filter_{—}alt_{—}idx[ 1 ][ xCtb >> CtbLog2SizeY ][ yCtb >> CtbLog2SizeY ] | ae(v) |
| } | |
| } | |
| if( slice_type = = I && qtbtt_dual_tree_intra_flag ) | |
| dual_tree_implicit_qt_split ( xCtb, yCtb, CtbSizeY, 0 ) | |
| Else | |
| coding_tree( xCtb, yCtb, CtbSizeY, CtbSizeY, 1, 1, 0, 0, 0, 0, 0, | |
| SINGLE_TREE, MODE_TYPE_ALL ) | |
| } | |

### 2.9. Cross-Component Adaptive Loop Filter (CC-ALF)

Cross-component adaptive loop filter (CC-ALF) uses luma sample values to refine each chroma component. Basically, CC-ALF generates a correction for each of the chroma samples by filtering luma samples, if CC-ALF is applied. It is applied as a loop filter step. The tool is controlled by information in the bit-stream, and this information includes both (a) filter coefficients for each chroma component and (b) a mask controlling the application of the filter for blocks of samples.

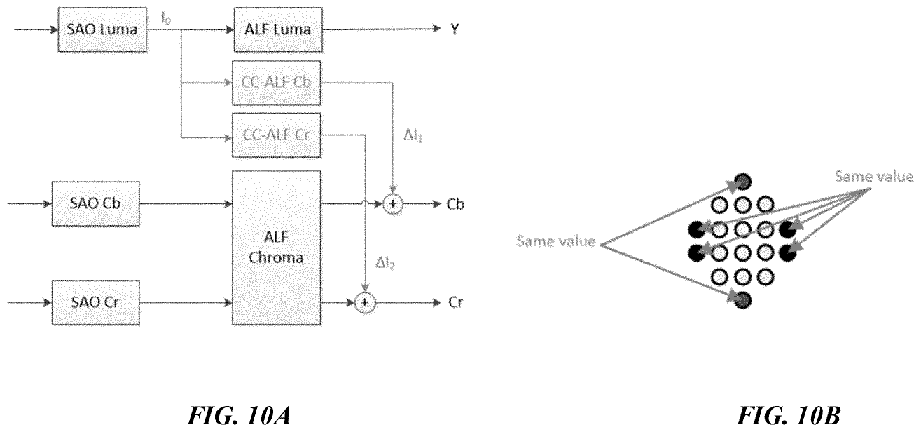

FIG. 10A below illustrates the placement of CC-ALF with respect to the other loop filters. CC-ALF operates by applying a linear, diamond shaped filter (as depicted in FIG. 10B) to the luma channel for each chroma component, which is expressed as

ΔIᵢ(x,y)=Σ₍ₓ_{₀}_{,y}_{₀}_{)∈S}_{ᵢ}I₀(x_{c}+x₀,y_{C}+y₀)cᵢ(x₀,y₀), (20)

wherein
(x,y) is chroma component i location being refined
(x_{C},y_{C}) is the luma location based on (x,y)
Sᵢ is filter support in luma for chroma component i
cᵢ(x₀,y₀) represents the filter coefficients

The CC-ALF process is further described in JVET-O0636. Key features characteristics include:
The luma location (x_{C}, y_{C}), around which the support region is centered, is computed based on the spatial scaling factor between the luma and chroma planes.
All filter coefficients are transmitted in the APS and have 8-bit dynamic range.
An APS may be referenced in the slice header.
CC-ALF coefficients used for each chroma component of a slice are also stored in a buffer corresponding to a temporal sublayer. Reuse of these sets of temporal sublayer filter coefficients is facilitated using slice-level flags.
The application of the CC-ALF filters is controlled on a variable block size and signalled by a context-coded flag received for each block of samples. The block size along with an CC-ALF enabling flag is received at the slice-level for each chroma component.
Boundary padding for the horizontal virtual boundaries makes use of repetition. For the remaining boundaries the same type of padding is used as for regular ALF.

### 2.9.1. Further Simplification of CC-ALF in JVET-P1008

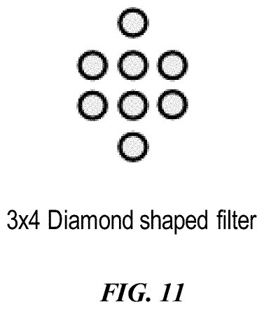

Compared to WET-P0080, the following new aspects are proposed to simplify the design of CC-ALF.
Complexity reduction
   Reduce the number of multiplies in the filter operation by changing filter shape to 3×4 diamond shape, as depicted in FIG. 11.
   Limit dynamic range of CC-ALF coefficients to 6-bits
   Allow for sharing of multipliers with chroma ALF
Alignment with ALF
   Limit filter selection to signaling at a CTU level
   Removal of the temporal layer coefficient buffers
   Use of symmetric line selection at ALF virtual boundary

Additionally, as the simplifications reduce coding efficiency, it is restricted that up to 4 filters per chroma component could be applied.

### 2.9.1.1. Syntax and Semantics of CC-ALF

The bolded, underlined text indicates proposed changes to the existing standard.

### 7.3.6 Slice Header Syntax

### 7.3.6.1 General Slice Header Syntax

| | Descriptor |
|---|---|
| slice_header( ) { | |
| slice_{—}pic_{—}parameter_{—}set_{—}id | ue(v) |
| if(rect_slice_flag \|\| NumBricksInPic > 1 ) | |
| slice_{—}address | u(v) |
| if( !rect_slice_flag && !single_brick_per_slice_flag ) | |
| num_{—}bricks_{—}in_{—}slice_{—}minus1 | ue(v) |
| non_{—}reference_{—}picture_{—}flag | u(1) |
| slice_{—}type | ue(v) |
| if( separate_colour_plane flag = = 1 ) | |
| colour_{—}plane_{—}id | u(2) |
| slice_{—}pic_{—}order_{—}cnt_{—}lsb | u(v) |
| if( nal_unit_type = = GDR_NUT ) | |
| recovery_{—}poc_{—}cnt | ue(v) |
| if( nal_unit_type = = IDR_W_RADL \|\| nal_unit_type = = IDR_N_LP \|\| | |
| nal_unit_type = = CRA_NUT \|\| NalUnitType = = GDR_NUT ) | |
| no_{—}output_{—}of_{—}prior_{—}pics_{—}flag | u(1) |
| if( output_flag_present_flag ) | |
| pic_{—}output_{—}flag | u(1) |
| if( ( nal_unit_type != IDR_W_RADL && nal_unit_type != IDR_N_LP ) \|\| | |
| sps_idr_rpl_present_flag ) { | |
| for( i = 0; i < 2; i++ ) { | |
| if( num_ref_pic_lists_in_sps[ i ] > 0 && !pps_ref_pic_list_sps_idc[ i ] && | |
| ( i = = 0 \|\| ( i = = 1 && rpl1_idx_present_flag ) ) ) | |
| ref_{—}pic_{—}list_{—}sps_{—}flag[ i ] | u(1) |
| if( ref_pic_list_sps_flag[ i ] ) { | |
| if( num_ref_pic_lists_in_sps[ i ] > 1 && | |
| ( i = = 0 \|\| ( i = = 1 && rpl1_idx_present_flag ) ) ) | |
| ref_{—}pic_{—}list_{—}idx [ i ] | u(v) |
| } else | |
| ref_pic_list_struct( i, num_ref_pic_lists_in_sps[ i ] ) | |
| for( j = 0; j < NumLtrpEntries[ i ][ RplsIdx[ i ] ]; j++ ) { | |
| if( ltrp_in_slice_header_flag[ i ][ RplsIdx[ i ] ] ) | |
| slice_{—}poc_{—}lsb_{—}lt[ i ][ j ] | u(v) |
| delta_{—}poc_{—}msb_{—}present_{—}flag[ i ][ j ] | u(1) |
| if( delta_poc_msb_present_flag[ i ][ j ] ) | |
| delta_{—}poc_{—}msb_{—}cycle_{—}lt[ i ][ j ] | ue(v) |
| } | |
| } | |
| if( ( slice_type != I && num_ref_entries[ 0 ][ RplsIdx[ 0 ] ] > 1 ) \|\| | |
| ( slice_type = = B && num_ref_entries[ 1 ][ RplsIdx[ 1 ] ] > ) ) { | |
| num_{—}ref_{—}idx_{—}active_{—}override_{—}flag | u(1) |
| if( num_ref_idx_active_override_flag ) | |
| for( i = 0; i < ( slice_type = = B ? 2: 1); i++ ) | |
| if( num_ref_entries[ i ][RplsIdx[ i ] ] > 1 ) | |
| num_{—}ref_{—}idx_{—}active_{—}minus1[ i ] | ue(v) |
| } | |
| } | |
| if( partition_constraints_override_enabled_flag ) { | |
| partition_{—}constraints_{—}override_{—}flag | ue(v) |
| if( partition_constraints_override_flag ) { | |
| slice_{—}log2_{—}diff_{—}min_{—}qt_{—}min_{—}cb_{—}luma | ue(v) |
| slice_{—}max_{—}mtt_{—}hierarchy_{—}depth_{—}luma | ue(v) |
| if( slice_max_mtt_hierarchy_depth_luma != 0 ) | |
| slice_{—}log2_{—}diff_{—}max_{—}bt_{—}min_{—}qt_{—}luma | ue(v) |
| slice_{—}log2_{—}diff_{—}max_{—}tt_{—}min_{—}qt_{—}luma | ue(v) |
| } | |
| if( slice_type = = I && qtbtt dual tree intra flag ) { | |
| slice_{—}log2_{—}diff_{—}min_{—}qt_{—}min_{—}cb_{—}chroma | ue(v) |
| slice_{—}max_{—}mtt_{—}hierarchy_{—}depth_{—}chroma | ue(v) |
| if( slice_max_mtt_hierarchy_depth_chroma ! = 0 ) | |
| slice_{—}log2_{—}diff_{—}max_{—}bt_{—}min_{—}qt_{—}chroma | ue(v) |
| slice_{—}log2_{—}diff_{—}max_{—}tt_{—}min_{—}qt_{—}chroma | ue(v) |
| } | |
| } | |
| } | |
| } | |
| if ( slice_type != I ) { | |
| if( sps_temporal_mvp_enabled_flag && !pps_temporal_mvp_enabled_idc ) | |
| slice_{—}temporal_{—}mvp_{—}enabled_{—}flag | u(1) |
| if( slice_type = = B && !pps_mvd_l1_zero_idc ) | |
| mvd_{—}l1_{—}zero_{—}flag | u(1) |
| if( cabac_init_present_flag ) | |
| cabac_{—}init_{—}flag | u(1) |
| if( slice_temporal_mvp_enabled_flag ) { | |
| if( slice_type = = B && !pps_collocated_from_l0_idc ) | |
| collocated_{—}from_{—}l0_{—}flag | u(1) |
| if( ( collocated_from_l0_flag && NumRefIdxActive[ 0 ] > 1 ) \|\| | |
| ( !collocated_from_l0_flag && NumRefIdxActive[ 1 ] > 1 ) ) | |
| collocated_{—}ref_{—}idx | ue(v) |
| } | |
| if( ( pps_weighted_pred_flag && slice_type = = P ) \|\| | |
| ( pps_weighted_bipred_flag && slice_type = = B ) ) | |
| pred_weight_table( ) | |
| if( !pps_six_minus_max_num_merge_cand_plus1 ) | |
| six_{—}minus_{—}max_{—}num_{—}merge_{—}cand | ue(v) |
| if( sps_afine_enabled_flag && | |
| !pps_five_minus_max_num_subblock_merge_cand_plus1 ) | |
| [Ed. (YK): There is a syntax element name subsetting issue here.] | |
| five_{—}minus_{—}max_{—}num_{—}subblock_{—}merge_{—}cand | ue(v) |
| if( sps_fpel_mmvd_enabled_flag ) | |
| slice_{—}fpel_{—}mmvd_{—}enabled_{—}flag | u(1) |
| if( sps_bdof_dmvr_slice_present_flag ) | |
| slice_{—}disable_{—}bdof_{—}dmvr_{—}flag | u(1) |
| if( sps_triangle_enabled_flag && MaxNumMergeCand >= 2 && | |
| !pps_max_num_merge_cand_minus_max_num_triangle_cand_minus1 ) | |
| [Ed. (YK): There is a syntax element name subsetting issue here.] | |
| max_{—}num_{—}merge_{—}cand_{—}minus_{—}max_{—}num_{—}triangle_{—}cand | ue(v) |
| } | |
| if ( sps_ibc_enabled_flag ) | |
| slice_six_{—}minus_{—}max num_{—}ibc_{—}merge_{—}cand | ue(v) |
| if( sps_joint_cbcr_enabled_flag ) | |
| slice_{—}joint_{—}cbcr_{—}sign_{—}flag | u(1) |
| slic_{—}eqp_{—}delta | se(v) |
| if( pps_slice_chroma_qp_offsets_present_flag ) { | |
| slice_{—}cb_{—}qp_{—}offset | se(v) |
| slice_{—}cr_{—}qp_{—}offset | se(v) |
| if( sps_joint_cbcr_enabled_flag ) | |
| slice_{—}joint_{—}cbcr_{—}qp_{—}offset | se(v) |
| } | |
| if( sps_sao_enabled_flag ) { | |
| slice_{—}sao_{—}luma_{—}flag | u(1) |
| if( ChromaArrayType != 0 ) | |
| slice_{—}sao_{—}chroma_{—}flag | u(1) |
| } | |
| if( sps_alf_enabled_flag ) { | |
| slice_{—}alf_{—}enabled_{—}flag | u(1) |
| if( slice_alf_enabled_flag ) { | |
| slice_{—}num_{—}alf_{—}aps_{—}ids_{—}luma | u(3) |
| for( i = 0; i < slice_num_alf_aps_ids_luma; i++ ) | |
| slice_{—}alf_{—}aps_{—}id_{—}luma[i] | u(3) |
| if( ChromaArrayType != 0 ) | |
| slice_{—}alf_{—}chroma_{—}idc | u(2) |
| if( slice_alf_chroma_idc ) | |
| slice_{—}alf_{—}aps_{—}id_{—}chroma | u(3) |
| } | |
| if( ChromaArrayType != 0 ) | |
| slice_{—}cross_{—}component_{—}alf_{—}cb_{—}enabled_{—}flag | u(1) |
| if( slice_{—}cross_{—}component_{—}alf_{—}cb_{—}enabled_{—}flag ) { | |
| slice_{—}cross_{—}component_{—}alf_{—}cb_{—}aps_{—}id | u(3) |
| } | |
| if( ChromaArrayType != 0 ) | |
| slice_{—}cross_{—}component_{—}alf_{—}cr_{—}enabled_{—}flag | u(1) |
| if( slice_{—}cross_{—}component_{—}alf_{—}cr_{—}enabled_{—}flag ) { | |
| slice_{—}cross_{—}component_{—}alf_{—}cr_{—}aps_{—}id | u(3) |
| } | |
| ... | |
| } | |
| byte_alignment( ) | |
| } | |

### Adaptive Loop Filter Data Syntax

| | Descriptor |
|---|---|
| alf_data( ) { | |
| alf_{—}luma_{—}filter_{—}signal_{—}flag | u(1) |
| alf_{—}chroma_{—}filter_{—}signal_{—}flag | u(1) |
| alf_{—}cross_{—}component_{—}cb_{—}filter_{—}signal_{—}flag | u(1) |
| alf_{—}cross_{—}component_{—}cr_{—}filter_{—}signal_{—}flag | u(1) |
| if( alf_luma_filter_signal_flag ) { | |
| alf_{—}luma_{—}clip_{—}flag | u(1) |
| alf_{—}luma_{—}num_{—}filters_{—}signalled_{—}minus1 | ue(v) |
| if( alf_luma_num_filters_signalled_minus1 > 0 ) { | |
| for( filtIdx = 0; filtIdx < NumAlfFilters; filtIdx++ ) | |
| alf_{—}luma_{—}coeff_{—}delta_{—}idx[ filtIdx ] | u(v) |
| } | |
| alf_{—}luma_{—}coeff_{—}signalled_{—}flag | u(1) |
| if( alf_luma_coeff_signalled_flag ) { | |
| for( sfIdx = 0; sfIdx <= alf_luma_num_filters_signalled_minus1; sfIdx++ ) | |
| alf_{—}luma_{—}coeff_{—}flag[ sfIdx ] | u(1) |
| } | |
| for( sfIdx = 0; sfIdx <= alf_luma_num_filters_signalled_minus1; sfIdx++ ) { | |
| if( alf_luma_coeff_flag[ sfIdx ] ) { | |
| for( j = 0; j < 12; j++ ) { | |
| alf_{—}luma_{—}coeff_{—}abs[ sfIdx ][ j ] | uek(v) |
| if( alf_luma_coeff_abs[ sfIdx ][ j ] ) | |
| alf_{—}luma_{—}coeff_{—}sign[ sfIdx ][ j ] | u(1) |
| } | |
| } | |
| } | |
| if( alf_luma_clip_flag ) { | |
| for( sfIdx = 0; sfIdx <= alf_luma_num_filters_signalled_minus1; sfIdx++ ) { | |
| if( alf_luma_coeff_flag[ sfIdx ] ) { | |
| for( j = 0; j < 12; j++ ) | |
| alf_{—}luma_{—}clip_{—}idx[ sfIdx ][ j ] | u(2) |
| } | |
| } | |
| } | |
| } | |
| if( alf_chroma_filter_signal_flag ) { | |
| alf_{—}chroma_{—}num_{—}alt_{—}filters_{—}minus1 | ue(v) |
| for( altIdx = 0; altIdx <= alf_chroma_num_alt_filters_minus1; altIdx++ ) { | |
| alf_{—}chroma_{—}clip_{—}flag[ altIdx ] | u(1) |
| for( j = 0; j < 6; j++ ) { | |
| alf_{—}chroma_{—}coeff_{—}abs[ altIdx ][ j ] | uek(v) |
| if( alf_chroma_coeff_abs[ altIdx ][ j ] > 0 ) | |
| alf_{—}chroma_{—}coeff_{—}sign[ altIdx ][ j ] | u(1) |
| } | |
| if( alf_chroma_clip_flag[ altIdx ] ) { | |
| for( j = 0; j < 6; j++ ) | |
| alf_{—}chroma_{—}clip_{—}idx[ altIdx ][ j ] | u(2) |
| } | |
| } | |
| } | |
| if ( alf_{—}cross_{—}component_{—}cb_{—}filter_{—}signal_{—}flag ){ | |
| alf_{—}cross_{—}component_{—}cb_{—}filters_{—}signalled_{—}minus1 | ue(v) |
| for(k = 0; k < (alf_{—}cross_{—}component_{—}cb_{—}filters_{—}signalled_{—}minus1+1); k++ ) { | |
| for ( j = 0; j < 8; j++ ) | |
| alf_{—}cross_{—}component_{—}cb_{—}coeff_{—}plus32[ k ][ j ] | u(6) |
| } | |
| } | |
| if ( alf_{—}cross_{—}component_{—}cr_{—}filter_{—}signal_{—}flag ) { | |
| alf_{—}cross_{—}component_{—}cr_{—}filters_{—}signalled_{—}minus1 | ue(v) |
| for( k = 0; k < (alf_{—}cross_{—}component_{—}cr_{—}filters_{—}signalled_{—}minus1+1); k++ ) { | |
| for ( j = 0; j < 8; j++ ) | |
| alf_{—}cross_{—}component_{—}cr_{—}coeff_{—}plus32[ k ][ j ] | u(6) |
| } | |
| } | |
| } | |

### 7.3.8.2 Coding Tree Unit Syntax

| | Descriptor |
|---|---|
| coding_tree_unit( ) { | |
| xCtb = (CtbAddrInRs % PicWidthInCtbsY) << CtbLog2SizeY | |
| yCtb = (CtbAddrInRs / PicWidthInCtbsY) << CtbLog2SizeY | |
| if( slice_sao_luma_flag \|\| slice_sao_chroma_flag ) | |
| sao( xCtb >> CtbLog2SizeY, yCtb >> CtbLog2SizeY ) | |
| if( slice_alf_enabled_flag ){ | |
| alf_{—}ctb_{—}flag[ 0 ][ xCtb >> CtbLog2SizeY ][ yCtb >> CtbLog2SizeY ] | ae(v) |
| if( alf_ctb_flag[ 0 ][ xCtb >> CtbLog2SizeY ][ yCtb >> CtbLog2SizeY ] ) { | |
| if( slice_num_alf_aps_ids_luma > 0 ) | |
| alf_{—}ctb_{—}use_{—}first_{—}aps_{—}flag | ae(v) |
| if( !alf_ctb_use_first_aps_flag ) { | |
| if( slice_num_alf_aps_ids_luma > 1 ) | |
| alf_{—}use_{—}aps_{—}flag | ae(v) |
| if( alf_use_aps_flag ) { | |
| if( slice_num_alf_aps_ids_luma > 2 ) | |
| alf_{—}luma_{—}prev_{—}filter_{—}idx_{—}minus1 | ae(v) |
| } else | |
| alf_{—}luma_{—}fixed_{—}filter_{—}idx | ae(v) |
| } | |
| } | |
| } | |
| if ( slice_{—}cross_{—}component_{—}alf_{—}cb_{—}enabled_{—}flag ) | |
| alf_{—}ctb_{—}cross_{—}component_{—}cb_{—}idc[ xCtb >> CtbLog2SizeY ][ yCtb >> CtbLog2SizeY ] | ae(v) |
| if( slice_alf_chroma_idc = = 1 \|\| slice_alf_chroma_idc = = 3 ) { | |
| alf_{—}ctb_{—}flag[ 1 ][ xCtb >> CtbLog2SizeY ][ yCtb >> CtbLog2SizeY ] | ae(v) |
| if( alf_ctb_flag[ 1 ][ xCt >> CtbLog2SizeY ][ yCtb >> CtbLog2SizeY ] | |
| && aps_alf_chroma_num_alt_filters_minus1 > 0 ) | |
| alf_{—}ctb_{—}filter_{—}alt_{—}idx[ 0 ][ xCtb>>CtbLog2SizeY ][ yCtb>>CtbLog2SizeY ] | ae(v) |
| } | |
| if ( slice_{—}cross_{—}component_{—}alf_{—}cr_{—}enabled_{—}flag ) | |
| alf_{—}ctb_{—}cross_{—}component_{—}cr_{—}idc[ xCtb >> CtbLog2SizeY ][ yCtb >> CtbLog2SizeY ] | ae(v) |
| if( slice_alf_chroma_idc = = 2 \|\| slice_alf_chroma_idc = = 3 ) { | |
| alf_{—}ctb_{—}flag[ 2 ][ xCtb >> CtbLog2SizeY ][ yCtb>>CtbLog2SizeY ] | ae(v) |
| if( alf_ctb_flag[ 2 ][ xCtb >> CtbLog2SizeY ][ yCtb >> CtbLog2SizeY ] | |
| && aps_alf_chroma_num_alt_filters_minus 1 > 0 ) | |
| alf_{—}ctb_{—}filter_{—}alt_{—}idx[ 1 ][ xCtb >> CtbLog2SizeY ][ yCtb >> CtbLog2SizeY ] | ae(v) |
| } | |
| if( slice_type = = I && qtbtt_dual_tree_intra_flag ) | |
| dual_tree_implicit_qt_split ( xCtb, yCtb, CtbSizeY, 0 ) | |
| else | |
| coding_tree( xCtb, yCtb, CtbSizeY, CtbSizeY, 1, 1, 0, 0, 0, 0, 0, | |
| SINGLE_TREE, MODE_TYPE_ALL ) | |
| } | |

alf_ctb_cross_component_cb_idc[xCtb>>CtbLog2SizeY][yCtb>>CtbLog2SizeY] equal to 0 indicates that the cross component Cb filter is not applied to block of Cb colour component samples at luma location (xCtb, yCtb). alf_cross_component_cb_idc[xCtb>>CtbLog2SizeY][yCtb>>CtbLog2SizeY] not equal to 0 indicates that the alf_cross_component_cb_idc[xCtb>>CtbLog2SizeY][yCtb>>CtbLog2SizeY]-th cross component Cb filter is applied to the block of Cb colour component samples at luma location (xCtb, yCtb)

alf_ctb_cross_component_cr_idc[xCtb>>CtbLog2SizeY][yCtb>>CtbLog2SizeY] equal to 0 indicates that the cross component Cr filter is not applied to block of Cr colour component samples at luma location (xCtb, yCtb). alf_cross_component_cr_idc[xCtb>>CtbLog2SizeY][yCtb>>CtbLog2SizeY] not equal to 0 indicates that the alf_cross_component_cr_idc[xCtb>>CtbLog2SizeY][yCtb>>CtbLog2SizeY]-th cross component Cr filter is applied to the block of Cr colour component samples at luma location (xCtb, yCtb)

### 2.10. Partitioning of Pictures, Subpictures, Slices, Tiles, and CTUs

2.10.1. Partitioning of Pictures into Subpictures, Slices, and Tiles

This sub clause specifies how a picture is partitioned into subpictures, slices, and tiles.

A picture is divided into one or more tile rows and one or more tile columns. A tile is a sequence of CTUs that covers a rectangular region of a picture. The CTUs in a tile are scanned in raster scan order within that tile.

A slice consists of an integer number of complete tiles or an integer number of consecutive complete CTU rows within a tile of a picture.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture contains one or more slices that collectively cover a rectangular region of a picture.

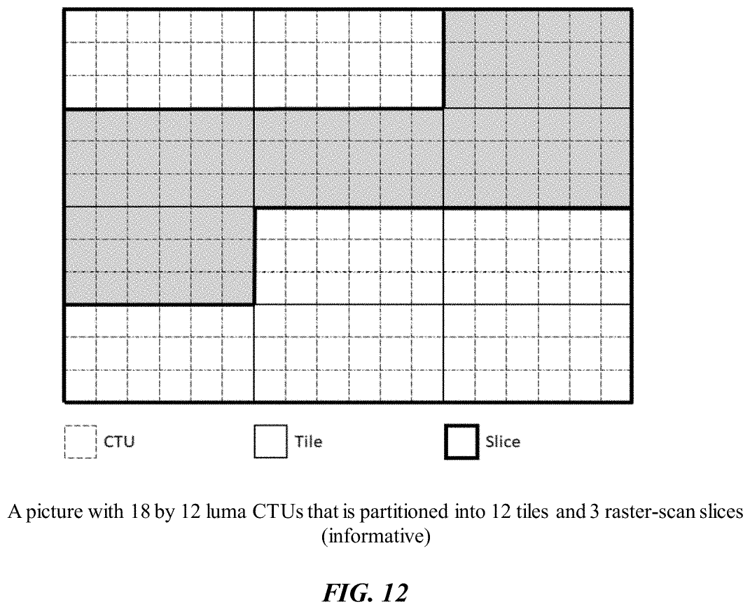

FIG. 12 shows an example of raster-scan slice partitioning of a picture, where the picture is divided into 12 tiles and 3 raster-scan slices.

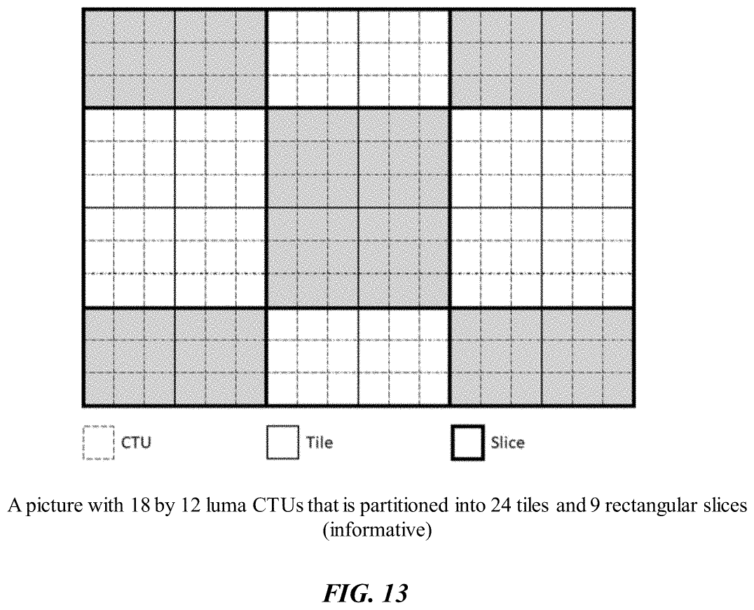

FIG. 13 shows an example of rectangular slice partitioning of a picture, where the picture is divided into 24 tiles (6 tile columns and 4 tile rows) and 9 rectangular slices.

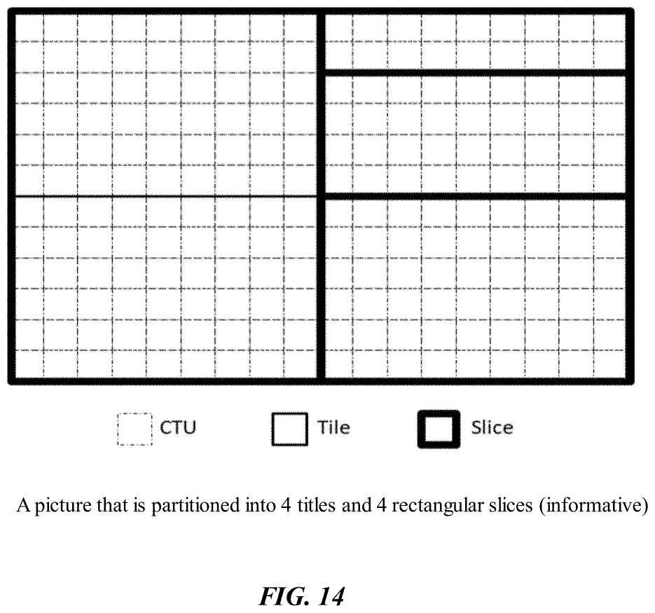

FIG. 14 shows an example of a picture partitioned into tiles and rectangular slices, where the picture is divided into 4 tiles (2 tile columns and 2 tile rows) and 4 rectangular slices.

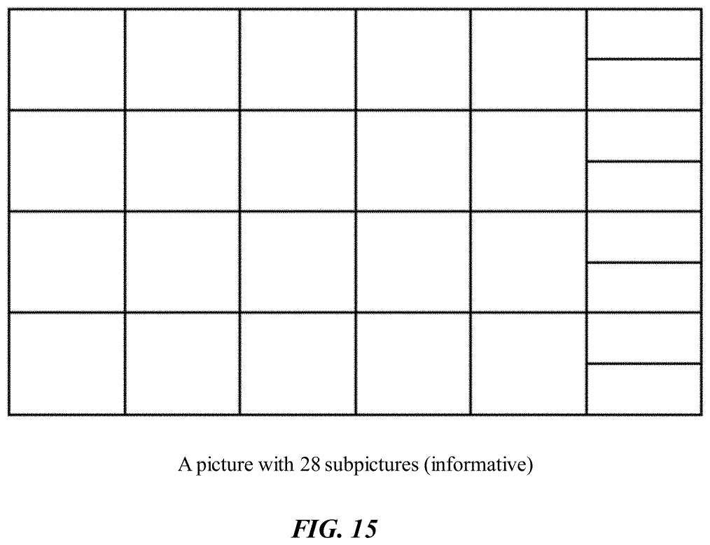

FIG. 15 shows an example of subpicture partitioning of a picture, where a picture is partitioned into 28 subpictures of varying dimensions. [Ed. (RS): Integrating FIG. 15 into FIG. 14 would help illustrate how the concepts align.]

When a picture is coded using three separate colour planes (separate_colour_plane_flag is equal to 1), a slice contains only CTUs of one colour component being identified by the corresponding value of colour_plane_id, and each colour component array of a picture consists of slices having the same colour_plane_id value. Coded slices with different values of colour_plane_id within a picture may be interleaved with each other under the constraint that for each value of colour_plane_id, the coded slice NAL units with that value of colour_plane_id shall be in the order of increasing CTU address in tile scan order for the first CTU of each coded slice NAL unit.

When separate_colour_plane_flag is equal to 0, each CTU of a picture is contained in exactly one slice. When separate_colour_plane_flag is equal to 1, each CTU of a colour component is contained in exactly one slice (i.e., information for each CTU of a picture is present in exactly three slices and these three slices have different values of colour_plane_id).

### 3. Drawbacks of Existing Implementations

The padding method used for ALF virtual boundaries may be denoted as “Two-side Padding” or “Mirrored Padding” wherein if one sample located at (i, j) is padded, then the corresponding sample located at (m, n) which share the same filter coefficient is also padded even if the sample is available, as depicted in FIG. 6 and FIG. 7.

The padding method used for picture boundaries/360-degree video virtual boundaries, normal boundaries (e.g., top and bottom boundaries) may be denoted as “One-side Padding” or “Repetitive Padding” wherein if one sample to be used is outside the boundaries, it is copied from an available one (e.g., the nearest available sample) inside the picture.

The current CC-ALF design has the following problem:
1. The padding method used in CC-ALF is not fully aligned with that used for non-linear ALF.
2. On/off control of CC-ALF is in CTB level. That is, if it is enabled, all chroma samples within the CTB shall be modified by adding a derived offset from filtered luma samples corresponding to one chroma sample.
3. For each chroma sample with CC-ALF and chroma ALF both applied, at least 3 clipping operations from three steps (chroma ALF filtering; CC-ALF offset derivation; and refinement of chroma filter samples to derive final chroma sample) are required. More specifically, the three stages are described as follows:
   a. Clip the filtered chroma sample in the chroma ALF process, i.e.,

sum_{chromaALF}=curr+(sum_{chromaALF}+64)>>7) (8 1290)

alfPicture[xCtbC+x][yCtbC+y]=Clip3(0,(1<<BitDepthC)−1,sum_{chromaALF}) (8-1291)
wherein ‘curr’ represents the chroma sample before being filtered; ‘sum_{chromaALF}’ represents the sum of chroma ALF filter coefficients times clipped chroma sample differences in a chroma ALF filter support
b. Clip the derived offset (denoted by sum) to a range according to chroma bit-depth, i.e.,

sum=Clip3(−(1<<(BitDepthC−1)),(1<<(BitDepthC−1))−1,sum) (8-1292)
wherein ‘sum’ represents the sum of CC-ALF filter coefficients times luma samples in a CC-ALF filter support
c. Clip the final refined chroma sample after adding the derived offset to the filtered chroma sample:

sum=alfPicture[xCtbC+x][yCtbC+y]+(sum+64)>>(7+(BitDepthY−BitDepthC)) (8-1293)

ccAlfPicture[xCtbC+x][y CtbC+y]=Clip3(0,(1<<BitDepth_{C})−1,sum) (8-1294)
wherein ‘alfPicture[xCtbC+x][yCtbC+y]’ represents the chroma sample after being filtered with chroma ALF (output of stage a); ‘sum’ represents the sum of CC-ALF filter coefficients times luma samples in a CC-ALF filter support (output of stage b); ccAlfPicture represents the final refined chroma sample (output of stage c, final stage).
4. As shown in equation (8-1293), the output of stage b, i.e., the variable sum is rounded with an offset equal to 64, which doesn't take the (BitDepthY−BitDepthC) into consideration. When (BitDepthY−BitDepthC) is unequal to 0, the rounding offset becomes sub optimal.

### 4. Example Techniques and Embodiments

The detailed embodiments described below should be considered as examples to explain general concepts. These embodiments should not be interpreted narrowly. Furthermore, these embodiments can be combined in any manner.

In this disclosure, the ALF filter may represent the filter applied to a given color component using the information of the given color component (e.g., Luma ALF filter (linear or non-linear) is applied to luma using luma information; chroma ALF filter is applied to chroma using chroma information, e.g., Cb chroma ALF filter is for filtering Cb samples; and Cr chroma ALF filter is for filtering Cr samples); while the CC-ALF filter may represent a filter applied to a first color component using information at least a second color component different from the first color component information (e.g., the first color component could be Cb or Cr; the second color component could be Luma).

In CC-ALF, “correction of a sample” may be derived, which will be added up to the sample before being processed by ALF, to generate the “refined sample”; or the “refined sample” may be derived directly.

A video unit may be a slice/tile/brick/sub-picture/picture/360-degree virtual picture (bounded by 360-degree virtual boundaries) or other kinds of video region that contains multiple samples/pixels.

In the following discussion, a sample is “at a boundary of a video unit” may mean that the distance between the sample and the boundary of the video unit is less or no greater than a threshold. A “line” may refer to may include samples at one same horizontal position or samples at one same vertical position (i.e., samples in the same row and/or samples in the same column). In one example, function Abs(x) may be defined as follows:

$$Abs ( x ) = \{ \begin{matrix}x & ; & x >= 0 \\ - x & ; & x < 0\end{matrix} .$$

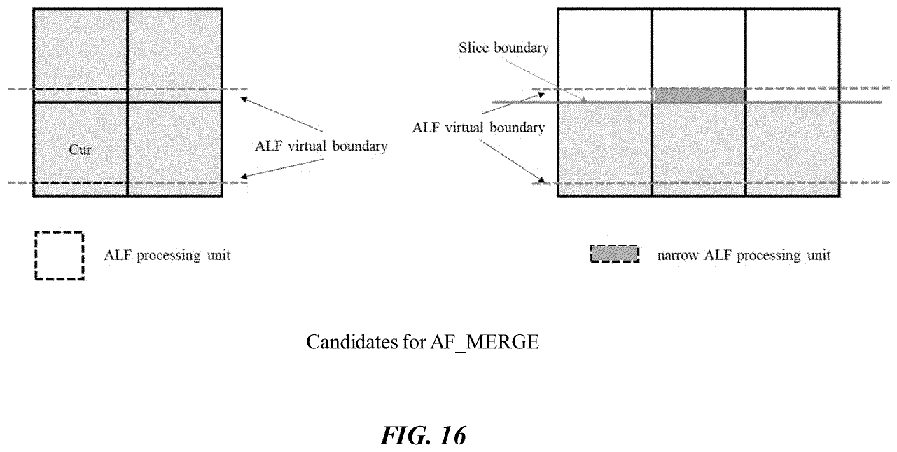

An “ALF processing unit” refers to a unit bounded by two horizontal boundaries and two vertical boundaries. The two horizontal boundaries may include two ALF virtual boundaries or one ALF virtual boundary and one picture boundary (or slice boundary/tile boundary/brick boundary/sub-picture boundary/360-degree virtual boundary). The two vertical boundaries may include two vertical CTU boundaries or one vertical CTU boundary and one picture boundary (or slice boundary/tile boundary/brick boundary/sub-picture boundary/360-degree virtual boundary). An example is shown in FIG. 16.

A “narrow ALF processing unit” refers to a unit bounded by two horizontal boundaries and two vertical boundaries. One horizontal boundary may include one ALF virtual boundary or one 360-degree virtual boundary, and the other horizontal boundary may include one slice/brick/tile/sub-picture boundary or one 360-degree virtual boundary or one picture boundary. The vertical boundary may be a CTU boundary or a picture boundary or a 360-degree virtual boundary or a slice/brick/tile/sub-picture boundary. An example is shown in FIG. 16.

In the disclosure, a neighbouring sample may be marked as “unavailable” if it is out of the current video unit containing the current sample (e.g., out of the current picture/sub-picture/tile/slice/brick/CTU) and filtering across such a video unit boundary is disallowed, or the neighbouring sample and the current sample are on different sides of a 360-degree virtual boundary and filtering across the 360-degree virtual boundary is disallowed. In yet another example, a neighbouring sample may be marked as “unavailable” if it is out of the current processing unit (such as ALF processing unit or narrow ALF processing unit), in a different video unit, and filtering across the video unit is disallowed.

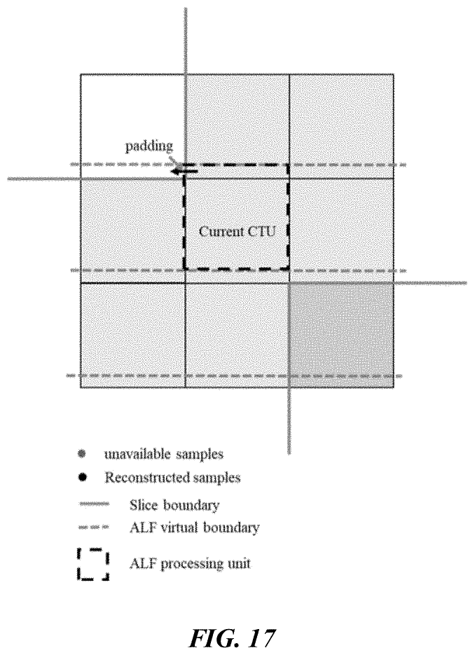

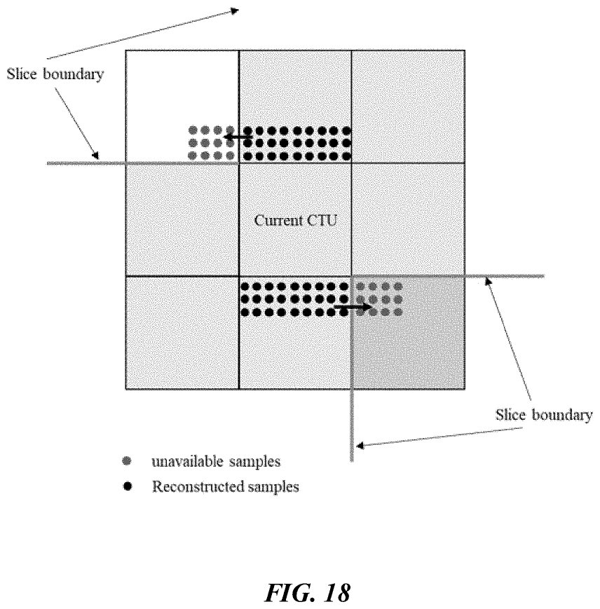

Similarly, for those samples to be filtered in CC-ALF (e.g., luma sample in current CC-ALF design), if a sample is located in a different video unit compared to the one containing the current chroma sample, it may be also marked as “unavailable”.
1. How to pad “unavailable” samples in CC-ALF may follow the same rule as that used for ALF.
   a. In one example, “Mirrored Padding” may be applied for padding “unavailable” samples at ALF virtual boundary in CC-ALF.
   b. In one example, “RepetitivePadding” may be applied for padding “unavailable” samples at slice/tile/brick/picture/sub-picture/360-degree virtual boundary in CC-ALF.
   c. In one example, “Repetitive Padding” may be applied to all boundaries except the ALF virtual boundary in CC-ALF.
      i. Alternatively, “Repetitive Padding” may be applied to all boundaries.
      ii. Alternatively, “Repetitive Padding” may be applied to all horizontal boundaries.
      iii. Alternatively, “Repetitive Padding” may be applied to all vertical boundaries.
      iv. Alternatively, “Mirrored Padding” may be applied to all horizontal boundaries.
      v. Alternatively, “Mirrored Padding” may be applied to all vertical boundaries.
      vi. Alternatively, “Mirrored Padding” may be applied to all boundaries.
   d. In one example, the “Repetitive Padding” may be applied to an “ALF processing unit” or a CTU or a “narrow ALF processing unit” or a “basic ALF processing unit” (defined below) or a video region different from all these process units.
   e. How to apply repetitive padding may depend on whether a neighboring sample is in a different neighbouring slice, where the current slice may be a raster-scan slice and/or the neighbouring slice may be a raster-scan slice.
      i. In one example, for a sample in a raster-scan slice, the “Repetitive Padding” may be applied to a “ALF processing unit”. E.g., a “unavailable” neighboring sample is padded with its nearest sample in the current “ALF processing unit”. An example is shown in FIG. 17, the left neighboring samples of the current “ALF processing unit” are “unavailable” and each of the “unavailable” sample is padded from its nearest sample in the current “ALF processing unit”.
2. Unavailable neighboring samples of a processing unit (e.g., an ALF processing unit or/and a narrow ALF processing unit or/and a CTU) may be padded in a predefined order in ALF or/and CC-ALF as follows.
   a. If the above neighboring samples of a processing unit are unavailable, they may be padded with the top row(s) of the processing unit.
      i. Alternatively, furthermore, the above-left neighboring sample(s) may be padded with the top-left sample of the processing unit.
      ii. Alternatively, furthermore, the above-right neighboring sample(s) may be padded with the top-right sample of the processing unit.
   b. If the below neighboring samples of a processing unit are unavailable, they may be padded with the bottom row(s) of the processing unit.
      i. Alternatively, furthermore, the below-left neighboring sample(s) may be padded with the bottom-left sample of the processing unit.
      ii. Alternatively, furthermore, the below-right neighboring sample(s) may be padded with the bottom-right sample of the processing unit.
   c. If the left neighboring samples of a processing unit are unavailable, they may be padded with the left column(s) of the processing unit.
   d. If the right neighboring samples of a processing unit are unavailable, they may be padded with the right column(s) of the processing unit.
   e. If the left neighboring samples and the above neighboring sample(s) of a processing unit are available and the above-left neighboring sample(s) of the processing unit are unavailable, the above neighboring sample(s) may be used to pad the above-left neighboring sample(s) of the processing unit.
      i. Alternatively, the left neighboring sample(s) may be used to pad the above-left neighboring sample(s) of the processing unit.
   f. If the above-left and above neighboring sample(s) of the processing unit are unavailable, and the leftneighboring sample(s) of the process unit are available, the left neighboring sample(s) may be used to pad the above-left neighboring sample(s) of the processing unit.
   g. If the above-left and left neighboring sample(s) of the processing unit are unavailable, and the above neighboring sample(s) of the process unit are available, the above neighboring sample(s) may be used to pad the above-left neighboring sample(s) of the processing unit.
   h. If the right neighboring sample(s) and the below neighboring sample(s) of a processing unit are available, and the below-right neighboring sample(s) of the processing unit are unavailable, the below neighboring sample(s) may be used to pad the below-right neighboring sample(s) of the processing unit.
      i. Alternatively, the right neighboring sample(s) may be used to pad the below-right neighboring sample(s) of the processing unit.
   i. If the below-right and below neighboring sample(s) of the processing unit are unavailable, and the right neighboring sample(s) of the process unit are available, the right neighboring sample(s) may be used to pad the below-right neighboring sample(s) of the processing unit.
   j. If the below-right and right neighboring sample(s) of the processing unit are unavailable, and the below neighboring sample(s) of the process unit are available, the below neighboring sample(s) may be used to pad the below-right neighboring sample(s) of the processing unit.
   k. If the above-right and right neighboring sample(s) of the processing unit are unavailable, and the above neighboring sample(s) of the process unit are available, the above neighboring sample(s) may be used to pad the above-right neighboring sample(s) of the processing unit.
   l. If the above-right and above neighboring sample(s) of the processing unit are unavailable, and the right neighboring sample(s) of the process unit are available, the right neighboring sample(s) may be used to pad the above-right neighboring sample(s) of the processing unit.
   m. If the below-left and left neighboring sample(s) of the processing unit are unavailable, and the below neighboring sample(s) of the process unit are available, the below neighboring sample(s) may be used to pad the below-left neighboring sample(s) of the processing unit.
   n. If the below-left and below neighboring sample(s) of the processing unit are unavailable, and the leftneighboring sample(s) of the process unit are available, the left neighboring sample(s) may be used to pad the below-left neighboring sample(s) of the processing unit.
   o. A processing unit may include N (N is an integer, e.g., N=4) rows of a CTU denoted by ctuUp and CtbSize−M (M is an integer, e.g., M=N) rows of a CTU denoted by ctuDown which is below the ctuUp. When checking whether a neighboring sample of the processing unit is available, the relationship between the neighboring sample and ctuDown may be considered.
      i. In one example, if a neighboring sample is in a video unit different from the ctuDown (e.g., the neighboring sample and the ctuDown belongs to different bricks/tiles/slices/sub-pictures or they are on different sides of a 360-degree virtual boundary) and the filtering across such video unit is disallowed, it is considered as “unavailable”.
      ii. Alternatively, the relationship between the neighboring sample and ctuUp may be considered to check the availability of a neighboring sample.
3. “Unavailable” samples in a raster-scan slice may be padded in a predefined order in CC-ALF or/and ALF. The current CTU is in the current slice.
   a. In one example, when the above CTU and the left CTU are in a same slice with the current slice, and the above-left CTU is in a slice different from the current slice, a “unavailable” neighboring sample in the above-left CTU is padded with its nearest neighboring sample in the above CTU of the current CTU. An example is shown in FIG. 18.
      i. Alternatively, a “unavailable” neighboring sample in the above-left CTU is padded with its nearest neighboring sample in the left CTU of the current CTU.
   b. In one example, when the below CTU and the right CTU are in a same slice with the current slice, and the below-right CTU is in a slice different from the current slice, a “unavailable” neighboring sample in the below-right CTU is padded with its nearest neighboring sample in the below CTU of the current CTU. An example is shown in FIG. 18.
      i. Alternatively, a “unavailable” neighboring sample in the below-right CTU is padded with its nearest neighboring sample in the right CTU of the current CTU.
4. A processing unit (e.g., an ALF processing unit or/and a narrow ALF processing unit or/and a CTU) may be split (horizontally or/and vertically) into multiple processing units when it is crossed by one or more brick/slice/tile/sub-picture boundary or/and 360-degree virtual boundary and the filtering across such boundary is disallowed.
   a. Alternatively, furthermore, the split process may be performed recursively until no processing unit is crossed by any brick/slice/tile/sub-picture boundary or/and 360-degree virtual boundary or/and ALF virtual boundary wherein filtering process across such boundary is disallowed, e.g., such boundaries can only be the boundaries of the processing unit. Such process unit is called the “basic ALF processing unit” hereinafter. The “basic ALF processing unit” may be an “ALF processing unit” if the “ALF processing unit” is not crossed by any of such boundaries.
   b. Alternatively, furthermore, the ALF process or/and CC-ALF process is performed after such split process is finished, e.g., the ALF process or/and CC-ALF is performed on the “basic ALF processing unit”.
   c. Alternatively, furthermore, the above padding method may be performed on the “basic ALF processing unit”.
   d. Different horizontal boundaries may be checked in a predefined order when generating the “basic ALF processing unit”.
      i. In one example, the checking order is ALF virtual boundary, 360-degree virtual boundary, and CTU boundary that is a brick/slice/tile/sub-picture boundary.
      ii. In one example, the checking order is 360-degree virtual boundary, ALF virtual boundary, and CTU boundary that is a brick/slice/tile/sub-picture boundary.
      iii. In one example, different checking orders may be used for the top boundary and the bottom boundary when generating the “basic ALF processing unit”.
         a) For example, for the top boundary, the checking order is ALF virtual boundary, 360-degree virtual boundary, and CTU boundary that is a brick/slice/tile/sub-picture boundary.
         b) For example, for the bottom boundary, the checking order is 360-degree virtual boundary, ALF virtual boundary, and CTU boundary that is a brick/slice/tile/sub-picture boundary.
   e. Different vertical boundaries may be checked in a predefined order when generating the “basic ALF processing unit”.
      i. In one example, the checking order is 360-degree virtual boundary and CTU boundary that is a brick/slice/tile/sub-picture boundary.
      ii. In one example, the checking order is CTU boundary that is a brick/slice/tile/sub-picture boundary and 360-degree virtual boundary.
      iii. In one example, different checking orders may be used for the left boundary and the right boundary when generating the “basic ALF processing unit”.
5. It is proposed that the ALF or/and CC-ALF process may be disabled for a sample at a video unit boundary if filtering process across such boundary is disallowed.
   a. In one example, if at least N (N is an integer) “unavailable” samples are involved in the ALF or/and CC-ALF process of a sample, the ALF or/and CC-ALF process is skipped for the sample. For example, N=1 or 2 or 3 etc.
   b. In one example, if a sample is at a horizontal video unit boundary and filtering process across such boundary is disallowed, and the vertical distance between the sample and the video unit boundary is smaller than or equal to M samples, ALF or/and CC-ALF is skipped for the sample. For example, M=0 or 1 or 2 or 3.
   c. In one example, if a sample is at a vertical video unit boundary and filtering process across such boundary is disallowed, and the horizontal distance between the sample and the video unit boundary is smaller than or equal to M samples, ALF or/and CC-ALF is skipped for the sample. For example, M=0 or 1 or 2 or 3.
6. It is proposed that the on/off control of ALF or/and CC-ALF may be decided for a video region that is different from a CTB.
   a. In one example, the video region is a “ALF processing unit” or a “narrow ALF processing unit” or a “basic ALF processing unit”.
   b. In one example, the on/off control may be signaled explicitly for the video region.
   c. In one example, the on/off control may be derived implicitly for the video region.
7. The signaled on/off control flags of CC-ALF may be associated with a first video unit (e.g., CTB), however, for a sample within the first video unit, the CC-ALF may still be disabled even if the signaled flag tells CC-ALF is enabled.
   a. In one example, whether to enable or disable CC-ALF for a sample within the first video unit may depend on the position of the sample.
   b. In one example, whether to enable or disable CC-ALF for a sample within the first video unit may depend on the luma samples involved in the CC-ALF process.
   c. In one example, whether to enable or disable CC-ALF for a sample within the first video unit may depend on the current sample and its neighboring samples, such as differences between them.
   d. In one example, whether to enable or disable CC-ALF for a sample within the first video unit may depend on the derived offset.
      i. In one example, if the derived offset is larger than (or no smaller than) a threshold, the offset may be discarded, i.e., CC-ALF is disabled (equal to the case offset is reset to 0).
      ii. In one example, if the derived offset is smaller than (or no greater than) a threshold, the offset may be discarded, i.e., CC-ALF is disabled (equal to the case offset is reset to 0).
   e. In one example, whether to enable or disable CC-ALF for a sample within the first video unit may depend on coded information of the block containing the chroma sample and/or neighboring blocks.
8. It is proposed to reduce the clipping process stages from 3 (as described in bullet 3 of section 3) to 1 or 2.
   a. In one example, the clipping processing chroma ALF filtering process is omitted if CC-ALF is enabled.
   b. In one example, the clipping process of derived offset in CC-ALF process is omitted.
   c. In one example, the above two methods are both applied.
9. The clipping range of derived offsets in CC-ALF process may be set differently from the range of [−(1<<(BitDepthC−1)), (1<<(BitDepthC−1))−1], inclusive.
   a. In one example, a smaller range may be utilized.
   b. In one example, the range may be independent from the bit-depth.
   c. In one example, the range may be adaptively changed from a first video region to another video region.
   d. In one example, the range may be derived from the non-linear clipping range used in the chroma ALF process (e.g., k(i, j) in equation (14).
10. The derived offset (e.g., the sum in bullet c of section 3) may be rounded with the rounding offset to a value depending on bit-depth information instead of being a fixed value (i.e., 64).
   a. In one example, the rounding offset may depend on bit-depth difference between the first color component (e.g., Y) and second color component (e.g, Cbr or Cr).
      i. Alternatively, furthermore, it may be also dependent on the bit-depth of CC-ALF filter coefficient.
      ii. In one example, the rounding offset may be set to (1<<(K−1+(BitDepthY−BitDepthC))) wherein K represent the bit-depth of CC-ALF filter coefficient; BitDepthY and BitDepthC represent the bit-depth of luma and chroma components, respectively.
   b. In one example, the followings may be applied to replace the equation (8-1293). Deleted texts are marked with double brackets (e.g., [[a]] denotes the deletion of the character “a”).

sum=alfPicture[xCtbC+x][yCtbC+y]+(sum+Off[[64]])>>(7+(BitDepthY−BitDepthC)) (8-1293)

ccAlfPicture[xCtbC+x][yCtbC+y]=Clip3(0,(1<<BitDepthC)−1,sum′) (8-1294)

wherein Off is set equal to (1<<(6+(BitDepthY−BitDepthC))).
11. It is proposed that chroma ALF and CC-ALF may be optimized jointly.
   a. In one example, when both chroma ALF and CC-ALF are enabled for a CTB or a video region, the clipping operation (e.g., clip the chroma sample generated by chroma ALF or/and CC-ALF to be within a predefined range which may depend on the chroma bitdepth) may be applied only in the CC-ALF process if the CC-ALF is applied after the chroma ALF.
   b. In one example, when both chroma ALF and CC-ALF are enabled for a CTB or a video region, the clipping operation (e.g., clip the chroma sample generated by chroma ALF or/and CC-ALF to be within a predefined range which may depend on the chroma bitdepth) may be applied only in the chroma ALF process if the CC-ALF is applied before the chroma ALF.
12. Suppose a sample Sin a first color component is modified as S=S+D, wherein D is an offset derived from an adaptive loop-filtering method using information of a second color component, such as CC-ALF, then D may be clipped adaptively. For example, S may be modified as S=S+Clip3(Dlow, Dhigh, D), wherein Dlow and/or Dhigh may be different for different sample.
   a. For example, Dlow and/or Dhigh may be signaled from encoder to the decoder.
   b. For example, Dlow and/or Dhigh may be derived depending on the value of S.
   c. For example, Dlow and/or Dhigh may be derived depending on the position of S.
   d. For example, several candidates of Dlow and/or Dhigh may be signaled or predefined. The selected candidates may be signaled from the encoder or derived at the decoder.
13. Suppose CC-ALF on a first sample S in a first sub-picture may depend on sample(s) in a second sub-picture, then S is determined to be filtered by CC-ALF or not depending on whether loop filter across sub-pictures is allowed for the first sub-picture and/or for the second sub-picture. (E.g. loop_filter_across_subpic_enabled_flag of the first sub-picture and/or of the second sub-picture).
   a. In one example, S is not filtered by CC-ALF if loop filter across sub-pictures is disallowed for the first sub-picture.
   b. In one example, S is not filtered by CC-ALF if loop filter across sub-pictures is disallowed for the second sub-picture.
   c. In one example, S is not filtered by CC-ALF if loop filter across sub-pictures is disallowed for the first sub-picture AND the second sub-picture.
   d. In one example, S is not filtered by CC-ALF if loop filter across sub-pictures is disallowed for the first sub-picture OR the second sub-picture.
14. Whether and/or how apply the above methods may be based on one or more conditions listed below:
   a. Video contents (e.g. screen contents or natural contents)
   b. A message signaled in the DPS/SPS/VPS/PPS/APS/picture header/slice header/tile group header/Largest coding unit (LCU)/Coding unit (CU)/LCU row/group of LCUs/TU/PU block/Video coding unit
   c. Position of CU/PU/TU/block/Video coding unit
   d. Decoded information of current block and/or its neighboring blocks
      i. Block dimension/Block shape of current block and/or its neighboring blocks
   e. Indication of the color format (such as 4:2:0, 4:4:4, RGB or YUV)
   f. Coding tree structure (such as dual tree or single tree)
   g. Slice/tile group type and/or picture type
   h. Color component (e.g. may be only applied on luma component and/or chroma component)
   i. Temporal layer ID
   j. Profiles/Levels/Tiers of a standard

### 5. Additional Embodiments

Text changes in the VVC draft are shown in underlined bold font in this document

### 6. Example Implementations of the Disclosed Technology

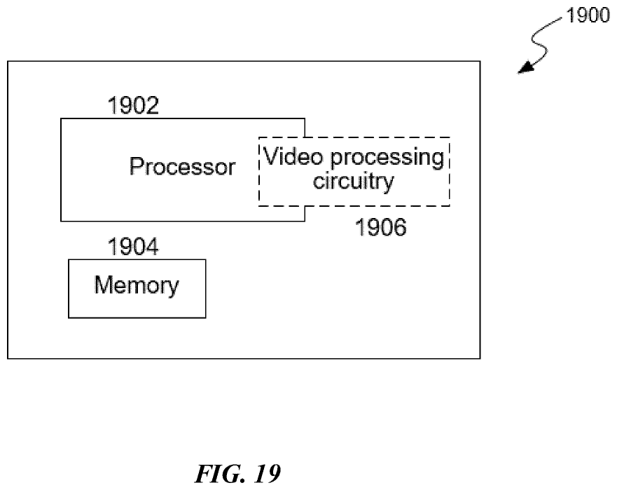

FIG. 19A is a block diagram of a video processing apparatus 1900. The apparatus 1900 may be used to implement one or more of the methods described herein. The apparatus 1900 may be embodied in a smartphone, tablet, computer, Internet of Things (IoT) receiver, and so on. The apparatus 1900 may include one or more processors 1902, one or more memories 1904 and video processing hardware 1906. The processor(s) 1902 may be configured to implement one or more methods described in the present document. The memory (memories) 1904 may be used for storing data and code used for implementing the methods and techniques described herein. The video processing hardware 1906 may be used to implement, in hardware circuitry, some techniques described in the present document, and may be partly or completely be a part of the processors 1902 (e.g., graphics processor core GPU or other signal processing circuitry).

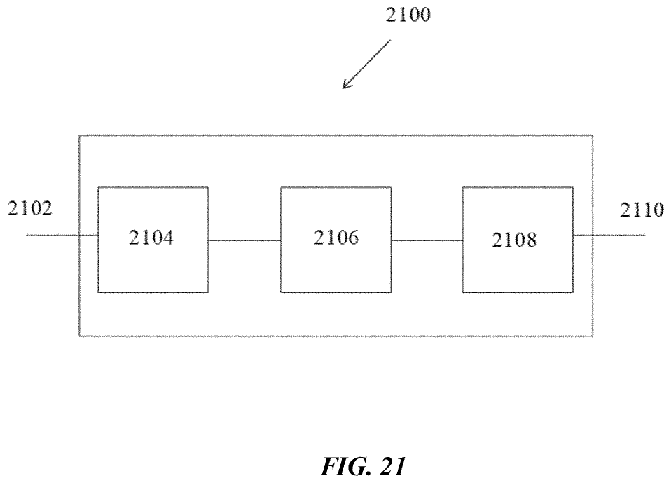

FIG. 21 is a block diagram showing an example video processing system 2100 in which various techniques disclosed herein may be implemented. Various implementations may include some or all of the components of the system 2100. The system 2100 may include input 2102 for receiving video content. The video content may be received in a raw or uncompressed format, e.g., 8 or 10 bit multi-component pixel values, or may be in a compressed or encoded format. The input 2102 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 2100 may include a coding component 2104 that may implement the various coding or encoding methods described in the present document. The coding component 2104 may reduce the average bitrate of video from the input 2102 to the output of the coding component 2104 to produce a coded representation of the video. The coding techniques are therefore sometimes called video compression or video transcoding techniques. The output of the coding component 2104 may be either stored, or transmitted via a communication connected, as represented by the component 2106. The stored or communicated bitstream (or coded) representation of the video received at the input 2102 may be used by the component 2108 for generating pixel values or displayable video that is sent to a display interface 2110. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include SATA (serial advanced technology attachment), PCI, IDE interface, and the like. The techniques described in the present document may be embodied in various electronic devices such as mobile phones, laptops, smartphones or other devices that are capable of performing digital data processing and/or video display.

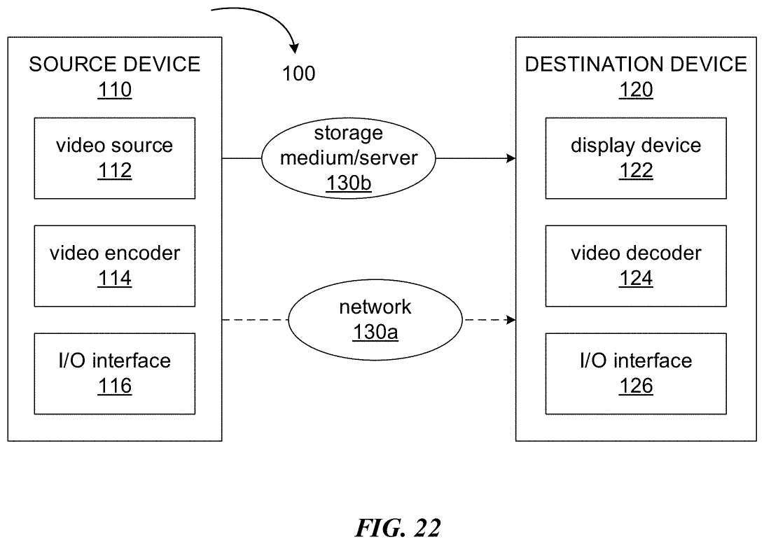

FIG. 22 is a block diagram that illustrates an example video coding system 100 that may utilize the techniques of this disclosure.

As shown in FIG. 22, video coding system 100 may include a source device 110 and a destination device 120. Source device 110 generates encoded video data which may be referred to as a video encoding device. Destination device 120 may decode the encoded video data generated by source device 110 which may be referred to as a video decoding device.

Source device 110 may include a video source 112, a video encoder 114, and an input/output (I/O) interface 116.

Video source 112 may include a source such as a video capture device, an interface to receive video data from a video content provider, and/or a computer graphics system for generating video data, or a combination of such sources. The video data may comprise one or more pictures. Video encoder 114 encodes the video data from video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 116 may include a modulator/demodulator (modem) and/or a transmitter. The encoded video data may be transmitted directly to destination device 120 via I/O interface 116 through network 130a. The encoded video data may also be stored onto a storage medium/server 130b for access by destination device 120.

Destination device 120 may include an I/O interface 126, a video decoder 124, and a display device 122.

I/O interface 126 may include a receiver and/or a modem. I/O interface 126 may acquire encoded video data from the source device 110 or the storage medium/server 130b. Video decoder 124 may decode the encoded video data. Display device 122 may display the decoded video data to a user. Display device 122 may be integrated with the destination device 120, or may be external to destination device 120 which be configured to interface with an external display device.

Video encoder 114 and video decoder 124 may operate according to a video compression standard, such as the High Efficiency Video Coding (HEVC) standard, Versatile Video Coding (VVC) standard and other current and/or further standards.

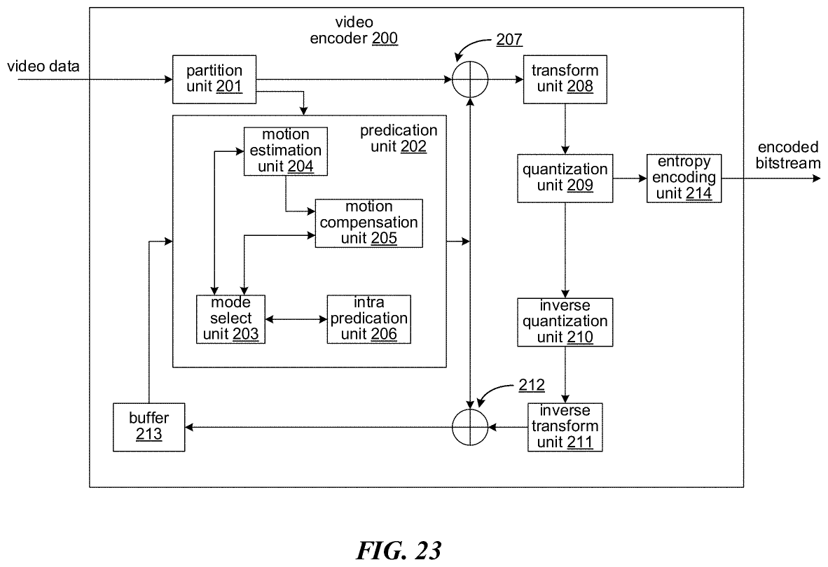

FIG. 23 is a block diagram illustrating an example of video encoder 200, which may be video encoder 114 in the system 100 illustrated in FIG. 22.

Video encoder 200 may be configured to perform any or all of the techniques of this disclosure. In the example of FIG. 23, video encoder 200 includes a plurality of functional components. The techniques described in this disclosure may be shared among the various components of video encoder 200. In some examples, a processor may be configured to perform any or all of the techniques described in this disclosure.

The functional components of video encoder 200 may include a partition unit 201, a predication unit 202 which may include a mode select unit 203, a motion estimation unit 204, a motion compensation unit 205 and an intra prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, video encoder 200 may include more, fewer, or different functional components. In an example, predication unit 202 may include an intra block copy (IBC) unit. The IBC unit may perform predication in an IBC mode in which at least one reference picture is a picture where the current video block is located.

Furthermore, some components, such as motion estimation unit 204 and motion compensation unit 205 may be highly integrated, but are represented in the example of FIG. 23 separately for purposes of explanation.

Partition unit 201 may partition a picture into one or more video blocks. Video encoder 200 and video decoder 300 may support various video block sizes.

Mode select unit 203 may select one of the coding modes, intra or inter, e.g., based on error results, and provide the resulting intra- or inter-coded block to a residual generation unit 207 to generate residual block data and to a reconstruction unit 212 to reconstruct the encoded block for use as a reference picture. In some example, Mode select unit 203 may select a combination of intra and inter predication (CIIP) mode in which the predication is based on an inter predication signal and an intra predication signal. Mode select unit 203 may also select a resolution for a motion vector (e.g., a sub-pixel or integer pixel precision) for the block in the case of inter-predication.

To perform inter prediction on a current video block, motion estimation unit 204 may generate motion information for the current video block by comparing one or more reference frames from buffer 213 to the current video block. Motion compensation unit 205 may determine a predicted video block for the current video block based on the motion information and decoded samples of pictures from buffer 213 other than the picture associated with the current video block.

Motion estimation unit 204 and motion compensation unit 205 may perform different operations for a current video block, for example, depending on whether the current video block is in an I slice, a P slice, or a B slice.

In some examples, motion estimation unit 204 may perform uni-directional prediction for the current video block, and motion estimation unit 204 may search reference pictures of list 0 or list 1 for a reference video block for the current video block. Motion estimation unit 204 may then generate a reference index that indicates the reference picture in list 0 or list 1 that contains the reference video block and a motion vector that indicates a spatial displacement between the current video block and the reference video block. Motion estimation unit 204 may output the reference index, a prediction direction indicator, and the motion vector as the motion information of the current video block. Motion compensation unit 205 may generate the predicted video block of the current block based on the reference video block indicated by the motion information of the current video block.

In other examples, motion estimation unit 204 may perform bi-directional prediction for the current video block, motion estimation unit 204 may search the reference pictures in list 0 for a reference video block for the current video block and may also search the reference pictures in list 1 for another reference video block for the current video block. Motion estimation unit 204 may then generate reference indexes that indicate the reference pictures in list 0 and list 1 containing the reference video blocks and motion vectors that indicate spatial displacements between the reference video blocks and the current video block. Motion estimation unit 204 may output the reference indexes and the motion vectors of the current video block as the motion information of the current video block. Motion compensation unit 205 may generate the predicted video block of the current video block based on the reference video blocks indicated by the motion information of the current video block.

In some examples, motion estimation unit 204 may output a full set of motion information for decoding processing of a decoder.

In some examples, motion estimation unit 204 may do not output a full set of motion information for the current video. Rather, motion estimation unit 204 may signal the motion information of the current video block with reference to the motion information of another video block. For example, motion estimation unit 204 may determine that the motion information of the current video block is sufficiently similar to the motion information of a neighboring video block.

In one example, motion estimation unit 204 may indicate, in a syntax structure associated with the current video block, a value that indicates to the video decoder 300 that the current video block has the same motion information as the another video block.

In another example, motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

Intra prediction unit 206 may perform intra prediction on the current video block. When intra prediction unit 206 performs intra prediction on the current video block, intra prediction unit 206 may generate prediction data for the current video block based on decoded samples of other video blocks in the same picture. The prediction data for the current video block may include a predicted video block and various syntax elements.

Residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 207 may not perform the subtracting operation.

Transform processing unit 208 may generate one or more transform coefficient video blocks for the current video block by applying one or more transforms to a residual video block associated with the current video block.

After transform processing unit 208 generates a transform coefficient video block associated with the current video block, quantization unit 209 may quantize the transform coefficient video block associated with the current video block based on one or more quantization parameter (QP) values associated with the current video block.

Inverse quantization unit 210 and inverse transform unit 211 may apply inverse quantization and inverse transforms to the transform coefficient video block, respectively, to reconstruct a residual video block from the transform coefficient video block. Reconstruction unit 212 may add the reconstructed residual video block to corresponding samples from one or more predicted video blocks generated by the predication unit 202 to produce a reconstructed video block associated with the current block for storage in the buffer 213.

After reconstruction unit 212 reconstructs the video block, loop filtering operation may be performed reduce video blocking artifacts in the video block.

Entropy encoding unit 214 may receive data from other functional components of the video encoder 200. When entropy encoding unit 214 receives the data, entropy encoding unit 214 may perform one or more entropy encoding operations to generate entropy encoded data and output a bitstream that includes the entropy encoded data.

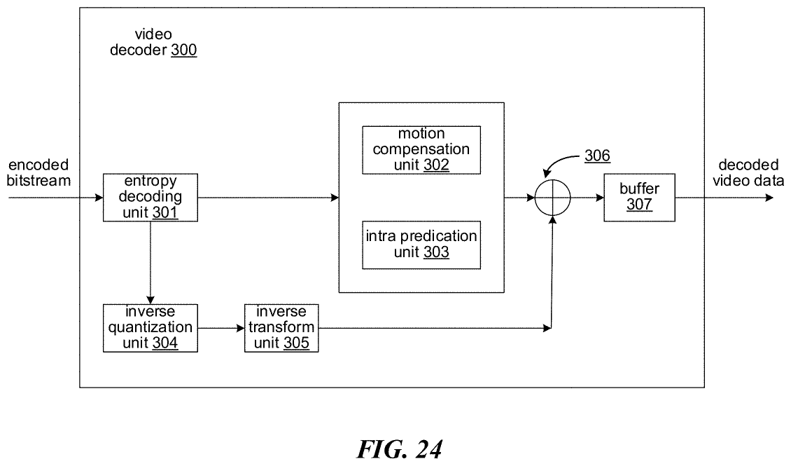

FIG. 24 is a block diagram illustrating an example of video decoder 300 which may be video decoder 114 in the system 100 illustrated in FIG. 22.

The video decoder 300 may be configured to perform any or all of the techniques of this disclosure. In the example of FIG. 24, the video decoder 300 includes a plurality of functional components. The techniques described in this disclosure may be shared among the various components of the video decoder 300. In some examples, a processor may be configured to perform any or all of the techniques described in this disclosure.

In the example of FIG. 24, video decoder 300 includes an entropy decoding unit 301, a motion compensation unit 302, an intra prediction unit 303, an inverse quantization unit 304, an inverse transformation unit 305, and a reconstruction unit 306 and a buffer 307. Video decoder 300 may, in some examples, perform a decoding pass generally reciprocal to the encoding pass described with respect to video encoder 200 (e.g., FIG. 23).

Entropy decoding unit 301 may retrieve an encoded bitstream. The encoded bitstream may include entropy coded video data (e.g., encoded blocks of video data). Entropy decoding unit 301 may decode the entropy coded video data, and from the entropy decoded video data, motion compensation unit 302 may determine motion information including motion vectors, motion vector precision, reference picture list indexes, and other motion information. Motion compensation unit 302 may, for example, determine such information by performing the AMVP and merge mode.

Motion compensation unit 302 may produce motion compensated blocks, possibly performing interpolation based on interpolation filters. Identifiers for interpolation filters to be used with sub-pixel precision may be included in the syntax elements.

Motion compensation unit 302 may use interpolation filters as used by video encoder 20 during encoding of the video block to calculate interpolated values for sub-integer pixels of a reference block. Motion compensation unit 302 may determine the interpolation filters used by video encoder 200 according to received syntax information and use the interpolation filters to produce predictive blocks.

Motion compensation unit 302 may uses some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence.

Intra prediction unit 303 may use intra prediction modes for example received in the bitstream to form a prediction block from spatially adjacent blocks. Inverse quantization unit 303 inverse quantizes, i.e., de-quantizes, the quantized video block coefficients provided in the bitstream and decoded by entropy decoding unit 301. Inverse transform unit 303 applies an inverse transform.

Reconstruction unit 306 may sum the residual blocks with the corresponding prediction blocks generated by motion compensation unit 202 or intra-prediction unit 303 to form decoded blocks. If desired, a deblocking filter may also be applied to filter the decoded blocks in order to remove blockiness artifacts. The decoded video blocks are then stored in buffer 307, which provides reference blocks for subsequent motion compensation.

Some embodiments of the disclosed technology include making a decision or determination to enable a video processing tool or mode. In an example, when the video processing tool or mode is enabled, the encoder will use or implement the tool or mode in the processing of a block of video, but may not necessarily modify the resulting bitstream based on the usage of the tool or mode. That is, a conversion from the block of video to the bitstream representation of the video will use the video processing tool or mode when it is enabled based on the decision or determination. In another example, when the video processing tool or mode is enabled, the decoder will process the bitstream with the knowledge that the bitstream has been modified based on the video processing tool or mode. That is, a conversion from the bitstream representation of the video to the block of video will be performed using the video processing tool or mode that was enabled based on the decision or determination.

In the present document, the term “video processing” may refer to video encoding video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream.

It will be appreciated that the disclosed methods and techniques will benefit video encoder and/or decoder embodiments incorporated within video processing devices such as smartphones, laptops, desktops, and similar devices by allowing the use of the techniques disclosed in the present document.

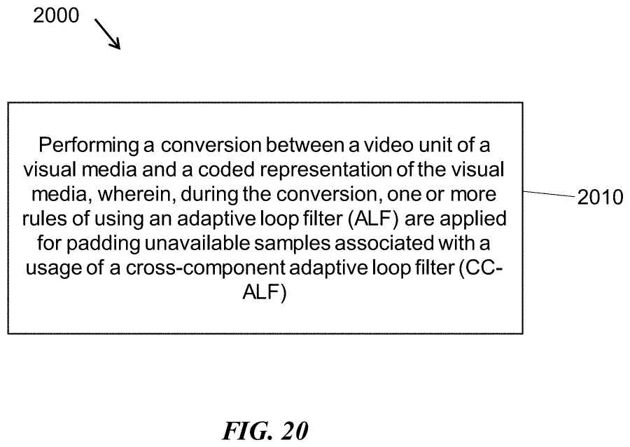

FIG. 20 is a flowchart for an example method 2000 of video processing. The method 2000 includes, at 2010, performing a conversion between a video unit of a visual media and a coded representation of the visual media, wherein, during the conversion, one or more rules of using an adaptive loop filter (ALF) are applied for padding unavailable samples associated with a usage of a cross-component adaptive loop filter (CC-ALF).

Some embodiments may be described using the following clause-based format. The first set of clauses show example embodiments of techniques discussed in the previous sections.

1. A method of video processing, comprising: performing a conversion between a video unit of a visual media and a coded representation of the visual media, wherein, during the conversion, one or more rules of using an adaptive loop filter (ALF) are applied for padding unavailable samples associated with a usage of a cross-component adaptive loop filter (CC-ALF).

2. The method of clause 1, wherein the ALF filter applied to a color component of the video unit is defined using an information provided by the color component of the video unit.

3. The method of any one or more of clauses 1 to 2, wherein the CC-ALF filter applied to a first color component of the video unit is defined using an information provided by at least a second color component of the video unit.

4. The method of any one or more of clauses 1 to 3, wherein the video unit corresponds to a slice, a tile, a brick, a sub-picture, a picture, or a 360-degree virtual picture bounded by 360-degree virtual boundaries.

5. The method of any one or more of clauses 1 to 4, wherein rules for mirrored padding are applied on the unavailable samples at one or more ALF virtual boundaries associated with the usage of the CC-ALF.

6. The method of any one or more of clauses 1 to 5, wherein rules for repetitive padding are applied on the unavailable samples at one of: a slice, a tile, a brick, a picture, a sub-picture, or a 360-degree virtual boundary associated with the usage of the CC-ALF.

7. The method of any one or more of clauses 1 to 6, wherein rules for repetitive padding are applied on one or more boundaries except at the at one or more ALF virtual boundaries associated with the usage of the CC-ALF.

8. The method of clause 7, wherein the one or more boundaries include one of: all boundaries, horizontal boundaries, or vertical boundaries.

9. The method of any one or more of clauses 1 to 6, wherein rules for mirrored padding are applied on one or more boundaries except at the at one or more ALF virtual boundaries associated with the usage of the CC-ALF.

10. The method of clause 9, wherein the one or more boundaries include one of: all boundaries, horizontal boundaries, or vertical boundaries.

11. The method of any one or more of clauses 1 to 10, wherein the video unit corresponds to an ALF processing unit, a coding tree unit (CTU), or a basic ALF processing unit

12. The method of clause 11, wherein the ALF processing unit defines a unit bounded by two horizontal boundaries and two vertical boundaries.

13. The method of clause 11, wherein the two horizontal boundaries includes one of: two ALF virtual boundaries, or one ALF virtual boundary and one boundary of a picture/slice/tile/brick/sub-picture or a 360-degree virtual boundary.

14. The method of clause 11, wherein the basic ALF processing unit is generated based on recursively splitting an ALF processing unit, a CTU, or a narrow ALF processing unit, and wherein boundaries of the basic ALF processing unit are not crossed by brick/slice/tile/sub-picture boundary, and/or 360-degree virtual boundary, and/or an ALF virtual boundary where filtering across a boundary is disallowed.

15. The method of any one or more of clauses 1 to 14, wherein rules for repetitive padding are based on whether a neighboring sample of the video unit is in a different neighboring slice.

16. The method of clause 15, wherein a current slice of the video unit is a raster-scan slice and wherein the neighboring slice is also a raster-scan slice.

17. The method of any one or more of clauses 15 to 16, wherein the current video unit is an ALF processing unit, and wherein an unavailable neighboring sample is padded using its nearest sample in the ALF processing unit.

18. A method of video processing, comprising:

performing a conversion between a video unit of the visual media and a coded representation of the visual media, wherein, during the conversion, one or more rules of padding unavailable samples of the video unit specify a predefined padding order associated with a usage of an ALF process or a CC-ALF process.

19. The method of clause 18, wherein the predefined padding order includes padding the unavailable samples using at least one top row of the video unit.

20. The method of clause 18, wherein the predefined padding order includes padding the unavailable samples using at least one bottom row of the video unit.

21. The method of clause 18, wherein the predefined padding order includes padding the unavailable samples using at least one left column of the video unit.

22. The method of clause 18, wherein the predefined padding order includes padding the unavailable samples using at least one right column of the video unit.

23. A method of video processing, comprising:

performing a conversion between a video unit of a visual media and a coded representation of the visual media, wherein, during the conversion, one or more rules of determining whether one or more neighboring samples of the video unit are available include a relationship between the one or more neighboring samples and a parameter associated with the video unit.

24. The method of clause 23, wherein the parameter (denoted ctuDown) associated with the video unit is calculated as ctuDown=CtbSize−M, wherein M is an integer.

25. The method of clause 24, wherein, if a neighboring sample is in a second video unit that has a different value than ctuDown, then the one or more rules specify that filtering across the second video unit is disallowed.

26. The method of clause 23, wherein the one or more rules additionally include a relationship between the one or more neighboring samples and a ctuUp parameter that is based on a number of rows of the video unit.

27. The method of any one or more of clauses 18 to 26, wherein the unavailable samples are neighboring samples.

28. The method of any one or more of clauses 18 to 26, wherein the unavailable samples are included in a raster-scan slice.

29. The method of clause 28, wherein an unavailable neighboring sample spatially located in an above-left CTU with respect to the video unit is padded with its nearest neighboring sample spatially located in an above CTU with respect to the video unit.

30. The method of clause 28, wherein an unavailable neighboring sample spatially located in a below-right CTU with respect to the video unit is padded with its nearest neighboring sample spatially located in a below CTU with respect to the video unit.

31. A method of video processing, comprising:

performing a conversion between a video unit of a visual media and a coded representation of the visual media, wherein, during the conversion, one or more rules of applying an ALF and/or a CC-ALF specify disabling application of the ALF and/or the CC-ALF on a sample located at a boundary of the video unit if filtering across the boundary is disallowed.

32. The method of clause 31, wherein applying the ALF and/or the CC-ALF is disabled upon determining that at least N neighboring samples associated with the ALF and/or the CC-ALF are unavailable.

33. The method of clause 31, wherein the boundary of the video unit is a horizontal boundary, and wherein applying the ALF and/or the CC-ALF is disabled upon determining that a vertical distance between the sample and the horizontal boundary of the video unit is smaller than or equal to M samples.

34. The method of clause 31, wherein the boundary of the video unit is a vertical boundary, and wherein applying the ALF and/or the CC-ALF is disabled upon determining that a horizontal distance between the sample and the vertical boundary of the video unit is smaller than or equal to M samples.

35. A method of video processing, comprising:

performing a conversion between a first video unit of visual media and a coded representation of the visual media, wherein, during the conversion, one or more rules of applying an ALF and/or a CC-ALF specify selectively turning the ALF and/or the CC-ALF on or off for a second video unit different from the first video unit.

36. The method of clause 35, wherein, whether the ALF and/or the CC-ALF is turned on or off for the second video unit is explicitly indicated in the coded representation of the second video unit.

37. The method of clause 35, wherein, whether the ALF and/or the CC-ALF is turned on or off for the second video unit is derived from the coded representation of the second video unit.

38. The method of any one or more of clauses 35 to 37, wherein a flag associated with the first video unit indicates enabling the ALF and/or the CC-ALF, and wherein, during the conversion, applying the ALF and/or the CC-ALF is selectively disabled for a sample located in the first video unit based on one or more conditions.

39. The method of clause 38, wherein the one or more conditions include a spatial position of the sample with respect to the first video unit.

40. The method of clause 38, wherein the one or more conditions include on luma sample values used in the CC-ALF.

41. The method of clause 38, wherein the one or more conditions include differences in sample values between the sample and its neighboring samples.

42. The method of clause 38, wherein the one or more conditions include a relationship between a value of an offset derived using filtered luma samples corresponding to a chroma sample and a threshold value.

43. A method of video processing, comprising:

performing a conversion between a first video unit of visual media and a coded representation of the visual media, wherein, during the conversion, one or more rules of selectively applying an ALF and/or a CC-ALF specify omitting at least one of three clipping operations, wherein a first clipping operation corresponds to a chroma ALF filtering, a second clipping operation corresponds to CC-ALF offset derivation, and a third clipping operation corresponds to refinement of chroma filter samples to derive a final chroma sample value.

44. The method of clause 43, wherein the one or more rules of applying an ALF and/or a CC-ALF specify omitting the first clipping operation if applying the CC-ALF is enabled.

45. The method of clause 43, wherein the one or more rules of applying an ALF and/or a CC-ALF specify omitting the second clipping operation if applying the CC-ALF is disabled.

46. The method of clause 43, wherein the one or more rules of applying an ALF and/or a CC-ALF specify omitting the first clipping operation and the second clipping operation.

47. The method of clause 43, wherein, during the second clipping operation CC-ALF offsets derived are defined to lie in a first range different from a second range that is expressed as [−(1<<(BitDepthC−1)), (1<<(BitDepthC−1))−1], wherein end points of the second range are included in the second range, and wherein BitDepthC is a bit depth value.

48. The method of clause 47, wherein the first range lacks a dependency on the bit depth value.

49. The method of clause 47, wherein a third range associated with a second video unit is defined differently from the first range associated with the first video unit.

50. The method of clause 47, wherein the first range is derived from a non-linear clipping range used in the first clipping operation corresponding to the chroma ALF filtering.

51. The method of clause 47, wherein, during the second clipping operation CC-ALF offsets derived are rounded using the bit-depth value instead of a fixed value.

52. The method of clause 47, wherein, during the second clipping operation CC-ALF offsets derived are rounded using the following expression:

sum=alfPicture[xCtbC+x][yCtbC+y]+(sum+Off)>>(7+(BitDepthY−BitDepthC)) ccAlfPicture[xCtbC+x][yCtbC+y]=Clip3(0, (1<<BitDepthC)−1, sum), wherein Off is set equal to (1<<(6+(BitDepthY−BitDepthC))), wherein alfPicture[xCtbC+x][yCtbC+y] represents a chroma sample after applying the first clipping operation, wherein sum represents a summation of CC-ALF filter coefficients times luma samples in a CC-ALF filter support after applying the second clipping operation, wherein ccAlfPicture represents the final chroma sample value after applying the third clipping operation.

53. A method of video processing, comprising:

performing a conversion between a video unit of visual media and a coded representation of the visual media, wherein, during the conversion, a chroma ALF process and/or a CC-ALF process are optimized jointly for the video unit.

54. The method of clause 53, wherein the conversion includes a clipping operation for clipping a chroma sample generated by the chroma ALF process and/or the CC-ALF process that results in the chroma sample to lie within a predefined range.

55. The method of clause 54, wherein the predefined range is based at least in part on a chroma bit depth value.

56. The method of clause 54, wherein the jointly optimized includes applying the clipping operation only during the CC-ALF process if the CC-ALF process is applied after the chroma ALF process.

57. The method of clause 54, wherein the jointly optimized includes applying the clipping operation only during the chroma ALF process if the CC-ALF process is applied before the chroma ALF process.

58. A method of video processing, comprising:

performing a conversion between a video unit of visual media and a coded representation of the visual media, wherein, during the conversion, a sample value of a first color component of the video unit is modified using an information of a second color component of the video unit, wherein the information of the second color component of the video unit is based on one or more parameters used in an adaptive loop filtering process.

59. The method of clause 58, wherein the one or more parameters used in an adaptive loop filtering process are clipping parameters, wherein the clipping parameters used on a first sample value are different from clipping parameters used on a second sample value, wherein the first sample value and the second sample value are included in the video unit.

60. The method of clause 59, wherein the clipping parameters are defined to lie in a range having a minimum clipping value and a maximum clipping value.

61. The method of clause 60, wherein the minimum clipping value and/or the maximum clipping value are explicitly signaled in the coded representation.

62. The method of clause 60, wherein the minimum clipping value and/or the maximum clipping value are based in part on the sample value.

63. The method of clause 60, wherein the minimum clipping value and/or the maximum clipping value are based in part on a spatial location of the sample value with respect to the video unit.

64. The method of clause 60, wherein the minimum clipping value and/or the maximum clipping value are predefined values.

65. The method of clause 60, wherein the minimum clipping value and/or the maximum clipping value are derived from other parameters.

66. A method of video processing, comprising:

performing a conversion between a first video unit of visual media and a coded representation of the visual media, wherein, during the conversion, an application of a CC-ALF process on a first sample of the first video unit is selectively based on a second sample of a second video unit of the visual media, wherein the selectively based includes a determination of whether a loop filter across video units is enabled or disabled.

67. The method of clause 66, wherein the application of the CC-ALF process on the first sample of the first video unit is skipped based on the determination that the loop filter across video units is disabled for the first video unit and/or the second video unit.

68. The method of clause 66, wherein the application of the CC-ALF process on the first sample of the first video unit is skipped based on the determination that the loop filter across video units is disabled for the first video unit.

69. The method of clause 66, wherein the application of the CC-ALF process on the first sample of the first video unit is skipped based on the determination that the loop filter across video units is disabled for the second video unit.

70. The method of one or more of clauses 66 to 69, wherein the determination of whether the loop filter across video units is enabled or disabled is based on reading a flag associated with the first video unit and/or the second video unit.

71. The method of any one or more of clauses 1 to 70, wherein the CC-ALF process and/or the ALF process is associated with at least one of: i. contents of the video unit, ii. a message signaled in DPS/SPS/VPS/PPS/APS/picture header/slice header/tile group header/Largest coding unit (LCU)/Coding unit (CU)/LCU row/group of LCUs/TU/PU block/Video coding unit, iii. a position of CU/PU/TU/block/Video coding unit, iv. a shape or dimension of the video unit and/or shapes or dimensions of neighboring video units, vii. an indication of a color format, viii. a coding tree structure, ix. a slice/tile group type and/or picture type, x. a color component of the video unit, xi. a temporal layer ID, or xii. a profile/level/tier of a standard.

72. A video decoding apparatus comprising a processor configured to implement a method recited in one or more of clauses 1 to 71.

73. A video encoding apparatus comprising a processor configured to implement a method recited in one or more of clauses 1 to 71.

74. A computer program product having computer code stored thereon, the code, when executed by a processor, causes the processor to implement a method recited in any of clauses 1 to 71.

75. A method, apparatus or system described in the present document.

The second set of clauses show example embodiments of techniques discussed in the previous sections.

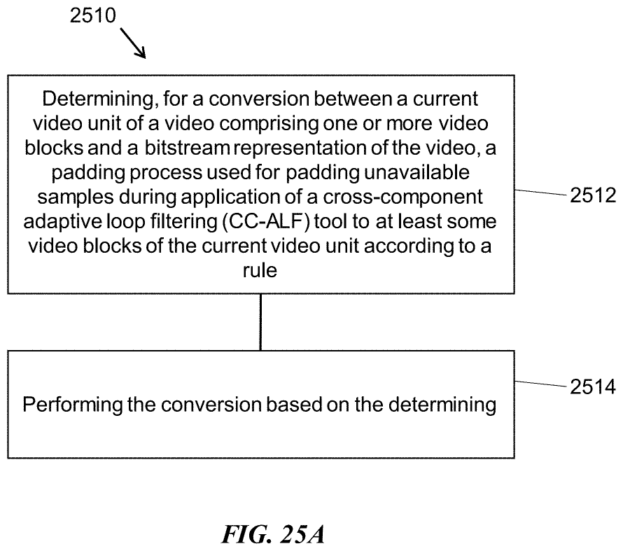

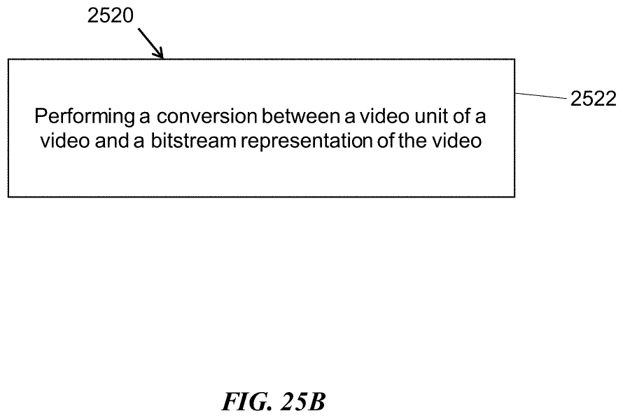

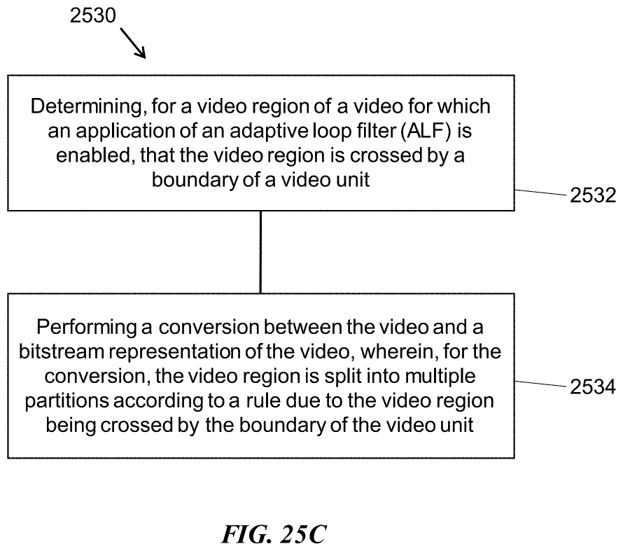

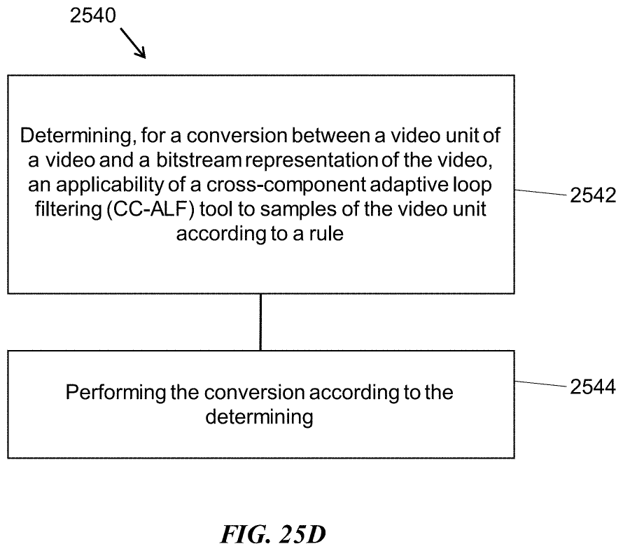

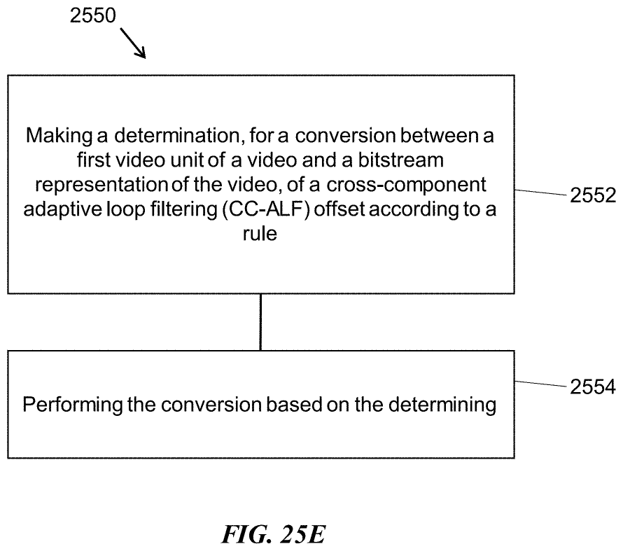

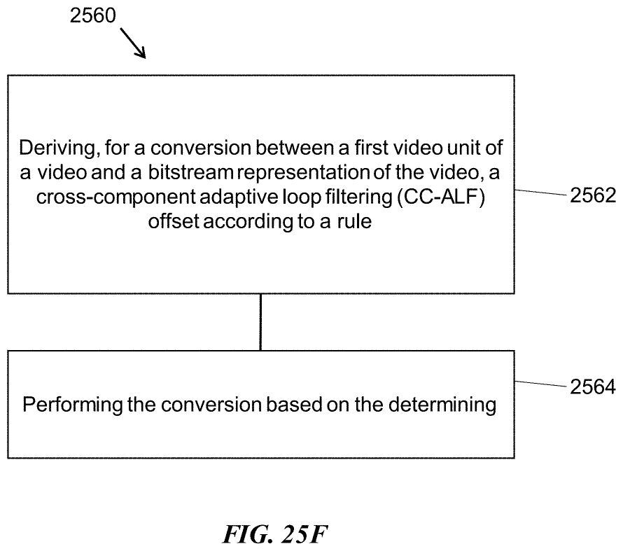

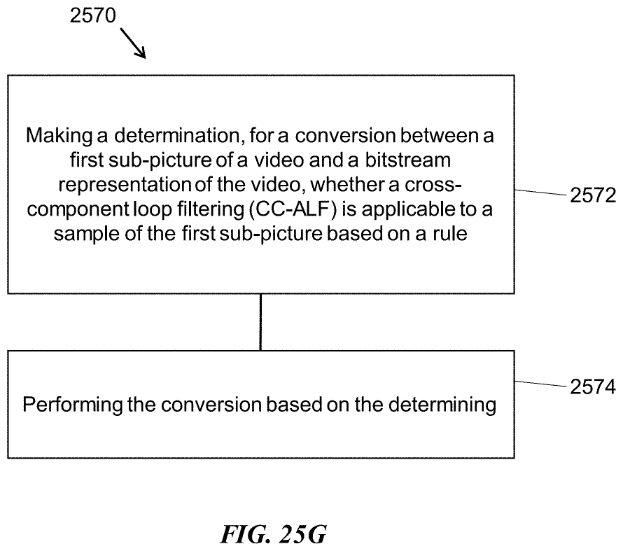

1. A method of video processing (e.g., method 2510 as shown in FIG. 25A), comprising: determining 2512, for a conversion between a current video unit of a video comprising one or more video blocks and a bitstream representation of the video, a padding process used for padding unavailable samples during application of a cross-component adaptive loop filtering (CC-ALF) tool to at least some video blocks of the current video unit according to a rule; and performing 2514 the conversion based on the determining; wherein the rule specifies that the padding process is also used for padding unavailable samples during application of an adaptive loop filtering (ALF) tool to one or more video blocks of the current video unit.

2. The method of clause 1, wherein the ALF tool is applied to a color component of the current video unit and the ALF tool includes correcting samples values of the color component using an information provided by the color component of the current video unit.

3. The method of any one or more of clauses 1 to 2, wherein the CC-ALF tool is applied to a first color component of the current video unit and includes correcting sample values of a first component of the current video unit using sample values of a second component of the current video unit.

4. The method of any one or more of clauses 1 to 3, wherein the current video unit corresponds to a slice, a tile, a brick, a sub-picture, a picture, or a 360-degree virtual picture bounded by 360-degree virtual boundaries.

5. The method of any one or more of clauses 1 to 4, wherein the padding process corresponds to mirrored padding that is applied on the unavailable samples at one or more ALF virtual boundaries associated with the usage of the CC-ALF tool.

6. The method of any one or more of clauses 1 to 4, wherein the padding process corresponds to repetitive padding that is applied on the unavailable samples at one of: a slice, a tile, a brick, a picture, a sub-picture, or a 360-degree virtual boundary associated with the usage of the CC-ALF.

7. The method of any one or more of clauses 1 to 4, wherein the padding process corresponds to repetitive padding is applied on one or more boundaries except at the one or more ALF virtual boundaries associated with the usage of the CC-ALF.

8. The method of clause 7, wherein the one or more boundaries include one of: all boundaries, horizontal boundaries, or vertical boundaries.

9. The method of any one or more of clauses 1 to 4, wherein the padding process corresponds to mirrored padding is applied on one or more boundaries except at the one or more ALF virtual boundaries associated with the usage of the CC-ALF.

10. The method of clause 9, wherein the one or more boundaries include one of: all boundaries, horizontal boundaries, or vertical boundaries.

11. The method of any one or more of clauses 1 to 10, wherein the current video unit corresponds to an ALF processing unit, a coding tree unit (CTU), or a basic ALF processing unit.

12. The method of clause 11, wherein the ALF processing unit defines a unit bounded by two horizontal boundaries and two vertical boundaries.

13. The method of clause 11, wherein the two horizontal boundaries include one of: two ALF virtual boundaries, or one ALF virtual boundary and one boundary of a picture/slice/tile/brick/sub-picture or a 360-degree virtual boundary.

14. The method of clause 11, wherein the basic ALF processing unit is generated based on recursively splitting an ALF processing unit, a CTU, or a narrow ALF processing unit, and wherein boundaries of the basic ALF processing unit are not crossed by brick/slice/tile/sub-picture boundary, and/or 360-degree virtual boundary, and/or an ALF virtual boundary where filtering across a boundary is disallowed.

15. The method of any one or more of clauses 1 to 4, wherein the padding process corresponds to repetitive padding that is based on whether a neighboring sample of the current video unit is in a different neighboring slice.

16. The method of clause 15, wherein a current slice of the current video unit is a raster-scan slice and wherein the neighboring slice of the current slice is also a raster-scan slice.

17. The method of any one or more of clauses 15 to 16, wherein the current video unit is an ALF processing unit, and wherein an unavailable sample is padded using its nearest sample in the ALF processing unit.

18. A method of video processing (e.g., method 2520 as shown in FIG. 25B), comprising: performing 2522 a conversion between a video unit of a video and a bitstream representation of the video, wherein, during the conversion, unavailable samples of the video unit are padded in a predefined padding order according to a rule in an application of an adaptive loop filtering (ALF) process or a cross-component adaptive loop filtering (CC-ALF) process.

19. The method of clause 18, wherein the video unit corresponds to a processing unit and the rule specifies the predefined padding order for padding the unavailable samples of the video unit.

20. The method of clause 18, wherein the predefined padding order includes padding the unavailable samples using at least one row or at least one column of the video unit, and wherein a location of the at least one row or the at least one column is determined based on locations of the unavailable samples.

21. The method of clause 18, wherein the predefined padding order includes padding the unavailable samples using at least one sample of the video unit, and wherein a location of the at least one sample is determined based on locations of the unavailable samples.

22. The method of clause 18, wherein an availability of at least one neighboring sample of the video unit is determined based on a relationship between the one or more neighboring samples and a parameter (ctuDown or ctuUp) associated with the video region, and wherein the video region corresponds to a processing unit that includes the ctuUP corresponding to N rows of a coding tree unit (CTU) and the ctuDown corresponding to ‘CtbSize−M’ rows of the CTU, whereby M is an integer.

23. The method of clause 22, wherein, if a neighboring sample is in a second video unit that is different from the ctuDown, then the rule specifies that filtering across the second video unit is disallowed.

24. The method of clause 18, wherein the video unit corresponds to a current coding tree unit included in a raster-scan slice and the rule specifies the predefined padding order for padding the unavailable samples of the video unit.

25. The method of clause 18, wherein the predefined padding order includes padding the unavailable samples located in an above-left CTU that is in a slice different from the raster-scan slice using its nearest neighboring sample located in an above CTU that is in the raster-scan slice.

26. The method of clause 18, wherein the predefined padding order includes padding the unavailable samples located in an above-left CTU that is in a slice different from the raster-scan slice using its nearest neighboring sample located in a left CTU that is in the raster-scan slice.

27. The method of clause 18, wherein the predefined padding order includes padding the unavailable samples located in an below-right CTU that is in a slice different from the raster-scan slice using its nearest neighboring sample located in a below CTU that is in the raster-scan slice.

28. The method of clause 18, wherein the predefined padding order includes padding the unavailable samples located in an below-right CTU that is in a slice different from the raster-scan slice using its nearest neighboring sample located in a right CTU that is in the raster-scan slice.

29. A method of video processing (e.g., method 2530 as shown in FIG. 25C), comprising: determining 2532, for a video region of a video for which an application of an adaptive loop filter (ALF) is enabled, that the video region is crossed by a boundary of a video unit; and performing 2534 a conversion between the video and a bitstream representation of the video, wherein, for the conversion, the video region is split into multiple partitions according to a rule due to the video region being crossed by the boundary of the video unit.

30. The method of clause 29, wherein a filtering process across the boundary is disallowed.

31. The method of clause 29, wherein the video region corresponds to an ALF processing unit, a narrow ALF processing unit, or a coding tree unit.

32. The method of clause 29, wherein the video unit corresponds to a brick, a slice, a tile, a sub-picture, or a 360-degree virtual picture.

33. The method of clause 29, wherein the rule further specifies to split the video region recursively until the video region is not across the boundary of the video unit.

34. The method of clause 29 or 30, wherein the filtering process corresponds to an ALF process or a CC-ALF process and wherein the rule further specifies that the filtering process is performed after a splitting process to split the video region is finished.

35. The method of clause 29, wherein a padding process used for padding at least one sample is performed on a basic ALF processing unit that is obtained after splitting the video region until the video region is not across the boundary of the video unit.

36. The method of clause 29, wherein the rule specifies to check different horizontal boundaries in a predefined order to generate a basic ALF processing unit that is obtained after splitting the video region until the video region is not across the boundary of the video unit.

37. The method of clause 36, wherein the predefined order is an ALF virtual boundary, a 360-degree virtual boundary, and a coding tree unit (CTU) boundary that is a boundary of the video unit.

38. The method of clause 36, wherein the predefined order is a 360-degree virtual boundary, an ALF virtual boundary, and a coding tree unit (CTU) boundary that is a boundary of the video unit.

39. The method of clause 36, wherein the rule specifies different predefined orders for a top boundary and a bottom boundary of the video unit.

40. The method of clause 29, wherein the rule specifies to check different vertical boundaries in a predefined order to generate a basic ALF processing unit that is obtained after splitting the video region until the video region is not across the boundary of the video unit.

41. The method of clause 40, wherein the predefined order is a 360-degree virtual boundary and a coding tree unit (CTU) boundary that is a boundary of the video unit.

42. The method of clause 40, wherein the predefined order is a coding tree unit (CTU) boundary and a 360-degree virtual boundary of the video unit.

43. The method of clause 40, wherein the rule specifies different predefined orders for a left boundary and a right boundary of the video unit.

44. A method of video processing, comprising: performing a conversion between a video unit of a video and a bitstream representation of the video according to a rule, wherein the rule specifies that applying an adaptive loop filtering (ALF) and/or a cross-component adaptive loop filtering (CC-ALF) to a sample located at a boundary of the video unit is disallowed in case that a filtering process across the boundary is disallowed.

45. The method of clause 44, wherein applying the ALF and/or the CC-ALF is disabled upon determining that at least N neighboring samples associated with the ALF and/or the CC-ALF are unavailable, whereby N is an integer.

46. The method of clause 44, wherein the boundary of the video unit is a horizontal boundary, and wherein applying the ALF and/or the CC-ALF is disabled upon determining that a vertical distance between the sample and the horizontal boundary of the video unit is smaller than or equal to M samples, whereby M is an integer.

47. The method of clause 44, wherein the boundary of the video unit is a vertical boundary, and wherein applying the ALF and/or the CC-ALF is disabled upon determining that a horizontal distance between the sample and the vertical boundary of the video unit is smaller than or equal to M samples, whereby M is an integer.

48. A method of video processing, comprising: performing a conversion between a video unit of a video and a bitstream representation of the video, wherein the bitstream representation conforms to a format rule, wherein the video region is different from a coding tree block, wherein the format rule specifies whether a syntax element is included in the bitstream representation indicative of an applicability of an adaptive loop filtering (ALF) tool and/or a cross-component adaptive loop filtering (CC-ALF) tool to the video region.

49. The method of clause 48, wherein the video region corresponds to an ALF processing unit.

50. The method of clause 48, wherein the applicability of the ALF tool and/or the CC-ALF tool is explicitly indicated in the bitstream representation.

51. The method of clause 48, wherein the applicability of the ALF tool and/or the CC-ALF tool is derived.

52. A method of video processing (e.g., method 2540 as shown in FIG. 25D), comprising: determining 2542, for a conversion between a video unit of a video and a bitstream representation of the video, an applicability of a cross-component adaptive loop filtering (CC-ALF) tool to samples of the video unit according to a rule; and performing 2544 the conversion according to the determining; wherein the bitstream representation includes an indication that the CC-ALF is available for the video unit; and wherein the rule specifies one or more conditions that override the indication.

53. The method of clause 52, wherein the one or more conditions include a spatial position of the sample with respect to the video unit.

54. The method of clause 52, wherein the one or more conditions include on luma sample values used in the CC-ALF.

55. The method of clause 52, wherein the one or more conditions include differences in sample values between the sample and its neighboring samples.

56. The method of clause 52, wherein the one or more conditions include a relationship between a value of an offset derived using filtered luma samples corresponding to a chroma sample and a threshold value.

57. The method of clause 52, wherein the one or more conditions include coded information of a block including a chroma sample and/or neighboring blocks of the block.

58. A method of video processing, comprising: performing a conversion between a video unit of a video and a bitstream representation of the video according to a rule, wherein the rule specifies that an arithmetic used during the conversion omits at least one of three clipping operations that include a first clipping operation corresponding to a chroma adaptive loop filtering (ALF) filtering, a second clipping operation corresponding to a cross-component adaptive loop filtering (CC-ALF) offset derivation, and a third clipping operation corresponding to a refinement of a chroma filtered sample to derive a final chroma sample value.

59. The method of clause 58, wherein the rule specifies omitting the first clipping operation in case that applying the CC-ALF is enabled.

60. The method of clause 58, wherein the rule specifies omitting the second clipping operation in case that applying the CC-ALF is disabled.

61. The method of clause 58, wherein the rule specifies omitting the first clipping operation and the second clipping operation.

62. A method of video processing (e.g., method 2550 as shown in FIG. 25E), comprising: making 2552 a determination, for a conversion between a first video unit of a video and a bitstream representation of the video, of a cross-component adaptive loop filtering (CC-ALF) offset according to a rule; and performing 2554 the conversion based on the determination, and wherein the rule specifies that the CC-ALF offset is clipped to a first range different from a second range that is expressed as [−(1<<(BitDepthC−1)), (1<<(BitDepthC−1))−1], wherein BitDepthC is a bit depth value.

63. The method of clause 62, wherein the first range lacks a dependency on the bit depth value.

64. The method of clause 62, wherein a third range associated with a second video unit is defined differently from the first range associated with the first video unit.

65. The method of clause 62, wherein the first range is derived from a non-linear clipping range used in another clipping operation corresponding to a chroma ALF filtering.

66. A method of video processing (e.g., method 2560 as shown in FIG. 25F), comprising: deriving 2562, for a conversion between a first video unit of a video and a bitstream representation of the video, a cross-component adaptive loop filtering (CC-ALF) offset according to a rule; and performing 2564 the conversion using the CC-ALF offset, and wherein the rule specifies that the CC-ALF offset is rounded with a rounding offset based on a bit-depth value instead of a fixed value.

67. The method of clause 66, wherein the rounding offset depends on bit-depth difference between a first color component and a second color component.

68. The method of clause 66, wherein the CC-ALF offset is rounded using a following expression: sum=alfPicture[xCtbC+x][yCtbC+y]+(sum+Off)>>(7+(BitDepthY−BitDepthC)) and ccAlfPicture[xCtbC+x][yCtbC+y]=Clip3(0, (1<<BitDepthC)−1, sum), wherein Off is set equal to (1<<(6+(BitDepthY−BitDepthC))), wherein alfPicture[xCtbC+x][yCtbC+y] represents a chroma sample after applying the first clipping operation, wherein sum represents a summation of CC-ALF filter coefficients times luma samples in a CC-ALF filter support after applying the second clipping operation, wherein ccAlfPicture represents the final chroma sample value after applying the third clipping operation, and wherein BitDepthC and BitDepthY represent bit-depths of luma and chroma components, respectively.

69. A method of video processing, comprising: performing a conversion between a video unit of a video and a bitstream representation of the video according to a rule, wherein the rule specifies that one or more processing steps used during a chroma adaptive loop filtering (ALF) process and/or a cross-component adaptive loop filtering (CC-ALF) process applied to samples of the video unit are same.

70. The method of clause 69, wherein the conversion includes a clipping operation for clipping a chroma sample generated by the chroma ALF process and/or the CC-ALF process that results in the chroma sample to lie within a predefined range.

71. The method of clause 70, wherein the predefined range is based at least in part on a chroma bit depth value.

72. The method of clause 70, wherein the clipping operation is applied only during the CC-ALF process if the CC-ALF process is applied after the chroma ALF process.

73. The method of clause 70, wherein the clipping operation is applied only during the chroma ALF process if the CC-ALF process is applied before the chroma ALF process.

74. A method of video processing, comprising: performing a conversion between a video unit of a video and a bitstream representation of the video according to a rule, wherein the rule specifies that, during the conversion, a value of a sample of a first color component of the video unit is modified by applying a modification using an information of a second color component of the video unit, wherein the modification is based on one or more parameters used in an adaptive loop filtering (ALF) process for the video unit.

75. The method of clause 74, wherein the one or more parameters used in an adaptive loop filtering process are clipping parameters, wherein the clipping parameters used on a first sample value are different from clipping parameters used on a second sample value, wherein the first sample value and the second sample value are included in the video unit.

76. The method of clause 75, wherein the clipping parameters are defined to lie in a range having a minimum clipping value and a maximum clipping value.

77. The method of clause 76, wherein the minimum clipping value and/or the maximum clipping value are explicitly signaled in the bitstream representation.

78. The method of clause 76, wherein the minimum clipping value and/or the maximum clipping value are based in part on the value of the sample.

79. The method of clause 76, wherein the minimum clipping value and/or the maximum clipping value are based in part on a spatial location of the value of the sample with respect to the video unit.

80. The method of clause 76, wherein the minimum clipping value and/or the maximum clipping value are signaled or predefined.

81. The method of clause 76, wherein the minimum clipping value and/or the maximum clipping value are derived from other parameters.

82. A method of video processing (e.g., method 2570 as shown in FIG. 25G), comprising: making 2572 a determination, for a conversion between a first sub-picture of a video and a bitstream representation of the video, whether a cross-component loop filtering (CC-ALF) is applicable to a sample of the first sub-picture based on a rule; and performing 2574 the conversion based on the determining, wherein the CC-ALF for the sample uses samples from a second sub-picture; and wherein the rule is based on whether loop filtering across a sub-picture boundary is allowed for the first sub-picture and/or the second sub-picture.

83. The method of clause 82, wherein the CC-ALF is skipped on the sample in case that the loop filtering across the sub-picture boundary is disallowed for the first sub-picture.

84. The method of clause 82, wherein the CC-ALF is skipped on the first sample in case that the loop filtering across the sub-picture boundary is disallowed for the second sub-picture.

85. The method of clause 82, wherein the CC-ALF is skipped on the first sample in case that the loop filtering across the sub-picture boundary is disallowed for the first sub-picture and/or the second sub-picture.

86. The method of one or more of clauses 82 to 84, wherein whether the loop filtering across the sub-picture boundary is allowed is based on a flag associated with the first sub-picture and/or the second sub-picture.

87. The method of any of previous clauses, wherein the method is further based on at least one of: 1) a type of video contents, 2) a message signaled in a sequence parameter set (SPS), a video parameter set (VPS), a picture parameter set (PPS), a dependency parameter set (DPS), an adaptation parameter set (APS), a picture header, a slice header, a tile group header, a largest coding unit (LCU), a coding unit (CU), a LCU row, a group of LCUs, a transform unit (TU), a prediction unit (PU) block, or a video coding unit, 3) a position of CU, PU, TU, block, or video coding unit, 4) decoded information of a current block and/or a neighboring block, 5) a dimension or shape of the current block and/or the neighboring block, 6) an indication of a color format, 7) a coding tree structure, 8) a slice type, a tile group type, and/or a picture type, 9) a type of a color component, 10) a temporal layer identifier, 11) profiles, levels, or tiers of a standard.

88. The method of any of clauses 1 to 87, wherein the conversion includes encoding the video into the bitstream representation.

89. The method of any of clauses 1 to 87, wherein the conversion includes decoding the video from the bitstream representation.

90. A video processing apparatus comprising a processor configured to implement a method recited in any one or more of clauses 1 to 89.

91. A computer readable medium storing program code that, when executed, causes a processor to implement a method recited in any one or more of clauses 1 to 89.

92. A computer readable medium that stores a coded representation or a bitstream representation generated according to any of the above described methods.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of processing video data, comprising:
determining, for a conversion between a current video unit of a video comprising one or more samples and a bitstream of the video, a padding process used for padding unavailable samples during application of a cross-component adaptive loop filtering (CC-ALF) tool to at least some samples of the current video unit, wherein the current video unit corresponds to a current coding tree unit; and
performing the conversion based on the determining;
wherein the CC-ALF tool is applied to a first color component of the current video unit and includes correcting sample values of a first component of the current video unit using sample values of a second component of the current video unit; and
wherein when a first unavailable sample is located in a below-right coding tree unit of the current video unit and a below coding tree unit of the current video unit and a right coding tree unit of the current video unit are both available, padding the first unavailable sample with its nearest neighboring sample located in the below coding tree unit.

2. The method of claim 1, wherein the below-right coding tree unit is located in a second slice that is different from a first slice in which the current video unit is located, the below coding tree unit and the right coding tree unit are both located in the first slice.

3. The method of claim 1, wherein when a second unavailable sample is located in an above-left coding tree unit of the current video unit and an above coding tree unit of the current video unit and a left coding tree unit of the current video unit are both available, padding the second unavailable sample with its nearest neighboring sample located in the above coding tree unit.

4. The method of claim 3, wherein the above-left coding tree unit is located in a second slice that is different from a first slice in which the current video unit is located, the above coding tree unit and the left coding tree unit are both located in the first slice.

5. The method of claim 1, wherein the padding process corresponds to a mirrored padding that is applied on the unavailable samples at one or more ALF virtual boundaries associated with the usage of the CC-ALF tool.

6. The method of claim 1, wherein the padding process corresponds to a one-side padding that is applied on the unavailable samples at one of: a slice, a tile, a picture, a sub-picture, or a 360-degree virtual boundary associated with the application of the CC-ALF.

7. The method of claim 1, wherein the padding process corresponds to a one-side padding that is applied on one or more boundaries except at one or more ALF virtual boundaries associated with the application of the CC-ALF.

8. The method of claim 1, wherein the conversion includes encoding the video into the bitstream.

9. The method of claim 1, wherein the conversion includes decoding the video from the bitstream.

10. An apparatus for processing video data comprising a processor and a non-transitory memory with instructions thereon, wherein the instructions upon execution by the processor, cause the processor to:
determine, for a conversion between a current video unit of a video comprising one or more samples and a bitstream of the video, a padding process used for padding unavailable samples during application of a cross-component adaptive loop filtering (CC-ALF) tool to at least some samples of the current video unit, wherein the current video unit corresponds to a current coding tree unit; and
perform the conversion based on the determination;
wherein the CC-ALF tool is applied to a first color component of the current video unit and includes correcting sample values of a first component of the current video unit using sample values of a second component of the current video unit; and
wherein when a first unavailable sample is located in a below-right coding tree unit of the current video unit and a below coding tree unit of the current video unit and a right coding tree unit of the current video unit are both available, padding the first unavailable sample with its nearest neighboring sample located in the below coding tree unit.

11. The apparatus of claim 10, wherein the below-right coding tree unit is located in a second slice that is different from a first slice in which the current video unit is located, the below coding tree unit and the right coding tree unit are both located in the first slice.

12. The apparatus of claim 10, wherein when a second unavailable sample is located in an above-left coding tree unit of the current video unit and an above coding tree unit of the current video unit and a left coding tree unit of the current video unit are both available, padding the second unavailable sample with its nearest neighboring sample located in the above coding tree unit; and
wherein the above-left coding tree unit is located in a second slice that is different from a first slice in which the current video unit is located, the above coding tree unit and the left coding tree unit are both located in the first slice.

13. The apparatus of claim 10, wherein the padding process corresponds to a mirrored padding that is applied on the unavailable samples at one or more ALF virtual boundaries associated with the usage of the CC-ALF tool; or
wherein the padding process corresponds to a one-side padding that is applied on the unavailable samples at one of: a slice, a tile, a picture, a sub-picture, or a 360-degree virtual boundary associated with the application of the CC-ALF; or
wherein the padding process corresponds to a one-side padding that is applied on one or more boundaries except at one or more ALF virtual boundaries associated with the application of the CC-ALF.

14. A non-transitory computer-readable storage medium storing instructions that cause a processor to:
determine, for a conversion between a current video unit of a video comprising one or more samples and a bitstream of the video, a padding process used for padding unavailable samples during application of a cross-component adaptive loop filtering (CC-ALF) tool to at least some samples of the current video unit, wherein the current video unit corresponds to a current coding tree unit; and
perform the conversion based on the determination;
wherein the CC-ALF tool is applied to a first color component of the current video unit and includes correcting sample values of a first component of the current video unit using sample values of a second component of the current video unit; and
wherein when a first unavailable sample is located in a below-right coding tree unit of the current video unit and a below coding tree unit of the current video unit and a right coding tree unit of the current video unit are both available, padding the first unavailable sample with its nearest neighboring sample located in the below coding tree unit.

15. The non-transitory computer-readable storage medium of claim 14, wherein the below-right coding tree unit is located in a second slice that is different from a first slice in which the current video unit is located, the below coding tree unit and the right coding tree unit are both located in the first slice.

16. The non-transitory computer-readable storage medium of claim 14, wherein when a second unavailable sample is located in an above-left coding tree unit of the current video unit and an above coding tree unit of the current video unit and a left coding tree unit of the current video unit are both available, padding the second unavailable sample with its nearest neighboring sample located in the above coding tree unit; and
wherein the above-left coding tree unit is located in a second slice that is different from a first slice in which the current video unit is located, the above coding tree unit and the left coding tree unit are both located in the first slice.

17. The non-transitory computer-readable storage medium of claim 14, wherein the padding process corresponds to a mirrored padding that is applied on the unavailable samples at one or more ALF virtual boundaries associated with the usage of the CC-ALF tool; or
wherein the padding process corresponds to a one-side padding that is applied on the unavailable samples at one of: a slice, a tile, a picture, a sub-picture, or a 360-degree virtual boundary associated with the application of the CC-ALF; or
wherein the padding process corresponds to a one-side padding that is applied on one or more boundaries except at one or more ALF virtual boundaries associated with the application of the CC-ALF.

18. A non-transitory computer-readable recording medium storing a bitstream of a video which is generated by a method performed by a video processing apparatus, wherein the method comprises:
determining, for a current video unit of a video comprising one or more samples, a padding process used for padding unavailable samples during application of a cross-component adaptive loop filtering (CC-ALF) tool to at least some samples of the current video unit, wherein the current video unit corresponds to a current coding tree unit; and
generating the bitstream based on the determining;
wherein the CC-ALF tool is applied to a first color component of the current video unit and includes correcting sample values of a first component of the current video unit using sample values of a second component of the current video unit; and
wherein when a first unavailable sample is located in a below-right coding tree unit of the current video unit and a below coding tree unit of the current video unit and a right coding tree unit of the current video unit are both available, padding the first unavailable sample with its nearest neighboring sample located in the below coding tree unit.

19. The non-transitory computer-readable recording medium of claim 18, wherein the below-right coding tree unit is located in a second slice that is different from a first slice in which the current video unit is located, the below coding tree unit and the right coding tree unit are both located in the first slice;
wherein when a second unavailable sample is located in an above-left coding tree unit of the current video unit and an above coding tree unit of the current video unit and a left coding tree unit of the current video unit are both available, padding the second unavailable sample with its nearest neighboring sample located in the above coding tree unit; and
wherein the above-left coding tree unit is located in a second slice that is different from a first slice in which the current video unit is located, the above coding tree unit and the left coding tree unit are both located in the first slice.

20. The non-transitory computer-readable recording medium of claim 18, wherein the padding process corresponds to a mirrored padding that is applied on the unavailable samples at one or more ALF virtual boundaries associated with the usage of the CC-ALF tool; or
wherein the padding process corresponds to a one-side padding that is applied on the unavailable samples at one of: a slice, a tile, a picture, a sub-picture, or a 360-degree virtual boundary associated with the application of the CC-ALF; or
wherein the padding process corresponds to a one-side padding that is applied on one or more boundaries except at one or more ALF virtual boundaries associated with the application of the CC-ALF.
